(19) United States
(12) Patent Application Publication
(10) Pub. No.: US 2014/0284001 A1
(43) Pub. Date: Sep. 25, 2014

(54) SYSTEMS AND METHODS FOR SPRAY DRYING IN MICROFLUIDIC AND OTHER SYSTEMS

(71) Applicants: President and Fellows Of Harvard College, Cambridg, MA (US); BASF SE, Ludwigshafen (DE)

(72) Inventors: Esther Amstad, Cambridge, MA (US); Christian Holtze, Frankfurt (DE); David A. Weitz, Bolton, MA (US)

(73) Assignees: President and Fellows of Harvard College, Cambridge, MA (US); BASF SE, Ludwigshafen (DE)

(21) Appl. No.: 14/350,965

(22) PCT Filed: Sep. 19, 2013
(86) PCT No.: PCT/US13/60522

§ 371 Date: Apr. 10, 2014

Related U.S. Application Data
(60) Provisional application No. 61/704,422, filed on Sep. 21, 2012.

(51) Int. Cl. B01D 1/20

(52) U.S. Cl. CPC B01D 1/20
USPC 159/4.01; 159/3; 159/48.1

(57) ABSTRACT

The present invention generally relates to microfluidics, and to spray drying and other drying techniques. By at least partially drying fluids within a microfluidic channel, instead of or in addition to conventional spray drying techniques, better control of the drying process can be achieved in certain aspects of the invention. In addition, various embodiments of the invention are generally directed to systems and methods for drying fluids contained within a channel such as a microfluidic channel. For example, a fluid may be partially or completely dried within a microfluidic channel, prior to being sprayed into a collection region. In some embodiments, gases such as air may be directed into a channel containing a fluid, which may facilitate drying of the fluid. In some cases, the fluid may be accelerated due to the introduction of gases into the channel, and in certain embodiments, droplets of fluid may be disrupted to form smaller droplets as a result. In certain cases, the fluids may also be dried to form supersaturated droplets.

### RELATED APPLICATIONS

This application claims the benefit of U.S. Provisional Patent Application Ser. No. 61/704,422, filed Sep. 21, 2012, entitled “Systems and Methods for Spray Drying in Microfluidic and Other Systems,” incorporated herein by reference in its entirety.

### FIELD OF INVENTION

The present invention generally relates to microfluidics, and to spray drying and other drying techniques.

### BACKGROUND

Spray drying is a technique that is commonly used to dry fluids, and is often used in diverse applications such as the spray drying of food (e.g., milk powder, coffee, tea, eggs, cereal, spices, flavorings, etc.), pharmaceutical compounds (e.g., antibiotics, medical ingredients, drugs, additives, etc.), industrial compounds (e.g., paint pigments, ceramic materials, catalysts, etc.), or the like. In spray drying, a fluid to be dried is typically expelled from a nozzle into a region that is dried and/or heated in order to cause the drying of the fluid to occur. The fluid is often liquid, although other fluids or materials may also be dried, for example wet or slushy solid materials. The region used for drying may contain air, nitrogen, or other inert gases, and in some cases is heated. The fluid is typically broken up, e.g., using a nozzle, to increase the exposed surface area and decrease the drying time of the fluid. However, such drying techniques may be hard to control, e.g., when a consistent size distribution of dried product is desired. In addition, the use of heated air may create the risk of thermal degradation of the spray-dried product in some cases.

### SUMMARY

The present invention generally relates to microfluidics, and to spray drying and other drying techniques. The subject matter of the present invention involves, in some cases, interrelated products, alternative solutions to a particular problem, and/or a plurality of different uses of one or more systems and/or articles.

In one aspect, the present invention is generally directed to a spray dryer for use in drying liquids. In one set of embodiments, the spray dryer comprises an article comprising a first microfluidic channel, second and third microfluidic channels each intersecting the first microfluidic channel at substantially non-right angles at a first intersection, and fourth and fifth microfluidic channels each intersecting the first microfluidic channel at substantially non-right angles at a second intersection. The spray dryer may also contain, in some embodiments, a collection region that receives output from the first microfluidic channel.

The present invention, in another aspect, is generally directed to a method of evaporating a liquid. In one set of embodiments, the method comprises an act of passing a liquid through a microfluidic channel such that at least about 20 vol % of the liquid evaporates while the liquid is contained within the microfluidic channel.

In yet another aspect, the present invention is generally directed to a method of spray drying a liquid. The method, in accordance with one set of embodiments, includes acts of passing a liquid through a microfluidic channel such that at least about 25 vol % of the liquid evaporates within the microfluidic channel, and spraying the unevaporated liquid into a collection region external of the microfluidic channel.

According to another aspect, the present invention is generally directed to a method of dispersing a fluidic droplet. In certain embodiments, the method includes an act of dispersing a fluidic droplet contained within a microfluidic channel into smaller fluidic droplets by accelerating the fluidic droplet within the microfluidic channel.

The method, in still another aspect, is generally directed to acts of providing a supersaturated fluidic droplet contained within a microfluidic channel, and directing the supersaturated fluidic droplet out of the microfluidic channel at a surface.

In yet another set of embodiments, the present invention is generally directed to a microfluidic device, comprising a first microfluidic channel, a first pair of microfluidic channels each intersecting the first microfluidic channel at a non-right angle at a first common intersection, and a second pair of microfluidic channels each intersecting the first microfluidic channel at a non-right angle at a second common intersection.

The microfluidic device, in still another set of embodiments, comprises a first microfluidic channel, a second microfluidic channel intersecting the first microfluidic channel at an acute angle, and a third microfluidic channel intersecting the first microfluidic channel at an obtuse angle.

According to another set of embodiments, the microfluidic channel comprises a first liquid accelerator region and a second liquid accelerator region.

The present invention, in still another aspect, is generally directed to a spray dryer. In one set of embodiments, the spray driver comprises a microfluidic channel comprising an internal drying region, and a surface positioned such that material expelled from the microfluidic channel impacts the surface.

The spray dryer, in another set of embodiments, includes an article comprising a first microfluidic channel, and a second microfluidic channel intersecting the first microfluidic channel at a substantially non-right angle. In some cases, the spray dryer may also comprise a collection region that receives output from the first microfluidic channel.

In yet another set of embodiments, the spray dryer comprises an article comprising a first microfluidic channel, and second and third microfluidic channels each intersecting the first microfluidic channel at substantially non-right angles at a first intersection. In some instances, one or both of the second and third microfluidic channels may be in fluidic communication with a source of pressurized gas. The spray dryer may also comprise a collection region that receives output from the first microfluidic channel, in certain embodiments of the invention.

In another set of embodiments, the method comprises an act of dispersing a fluidic droplet contained within a microfluidic channel into smaller fluidic droplets by applying a shear force to the fluidic droplet.

In another aspect, the present invention encompasses methods of making one or more of the embodiments described herein, for example, spray drying and other drying techniques involving microfluidics. In still another aspect, the present invention encompasses methods of using one or more of the embodiments described herein, for example, spray drying and other drying techniques involving microfluidics.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates a channel used for drying a fluid, in accordance with one embodiment of the invention;

FIGS. 2A-2C illustrate a microfluidic device for drying a fluid, in accordance with another embodiment of the invention;

FIGS. 3A-3B illustrate spray dried particles, produced in various embodiments of the invention;

FIGS. 4A-4B illustrate acceleration of droplets in channels, in certain embodiments of the invention;

FIGS. 5A-5C illustrate air velocities and droplet sizes, in accordance with certain embodiments of the invention;

FIGS. 6A-6D illustrate spray dried particles, produced in further embodiments of the invention;

FIGS. 7A-7B illustrate the speed of droplets inside a channel, in yet another embodiments of the invention;

FIGS. 8A-8E illustrate particles produced in accordance with various embodiments of the invention;

FIGS. 9A-9B illustrate air velocities and droplet sizes, in accordance with some embodiments of the invention;

FIGS. 10A-10C illustrate flow characteristics of certain embodiments of the invention; and

FIGS. 11A-11C illustrate various channel heights in accordance with certain embodiments of the invention.

### DETAILED DESCRIPTION

The present invention generally relates to microfluidics, and to spray drying and other drying techniques. By at least partially drying fluids within a microfluidic channel, instead of or in addition to conventional spray drying techniques, better control of the drying process can be achieved in certain aspects of the invention. In addition, various embodiments of the invention are generally directed to systems and methods for drying fluids contained within a channel such as a microfluidic channel. For example, a fluid may be partially or completely dried within a microfluidic channel, prior to being sprayed into a collection region. In some embodiments, gases such as air may be directed into a channel containing a fluid, which may facilitate drying of the fluid. In some cases, the fluid may be accelerated due to the introduction of gases into the channel, and in certain embodiments, droplets of fluid may be disrupted to form smaller droplets as a result. In certain cases, the fluids may also be dried to form supersaturated droplets.

Accordingly, certain aspects of the present invention are generally related to spray dryers to at least partially dry fluids (typically, liquids), e.g., to produce particles such as microparticles or nanoparticles. In a spray dryer, a fluid is dried, at least in part, by spraying the fluid as small droplets, e.g., through a nozzle into a collection region. However, in some embodiments, as discussed herein, the fluid may be at least partially dried prior to being sprayed into the collection region. For example, gases such as air may be directed into a microfluidic channel containing a fluid (which may be present within the channel, e.g., as droplets or films), which can cause at least partial drying of the fluid within the channel and/or cause the liquid to become disrupted to form smaller droplets, which may enhance drying.

In some embodiments, a fluid may be accelerated within the channel due to the introduction of such gases. In some cases, fluids within the channel may become elongated or disrupted under certain conditions, e.g., breaking into smaller droplets. This may speed up or accelerate the drying process. In addition, in certain embodiments, evaporation may occur within the channel more quickly, such that the air within the channel does not have to be heated. Furthermore, in some instances, the fluids within the channel may reach supersonic speeds, further increasing the rate of evaporation. Thus, for instance, the droplets may partially or completely dry within the channel, e.g., forming particles, and/or the droplets may be expelled into a drying region (for example, a region that is heated and/or has reduced humidity) to finish the drying process, e.g., in the manner of a conventional spray dryer.

Spray drying techniques such as those discussed herein may be used in a variety of applications where drying is desired. For example, spray drying may be used to dry thermally sensitive materials or thermally degradable materials, and/or to dry a fluid. In some cases, spray drying may also be used to create relatively uniform particles, e.g., due to drying of the fluid at a controlled rate.

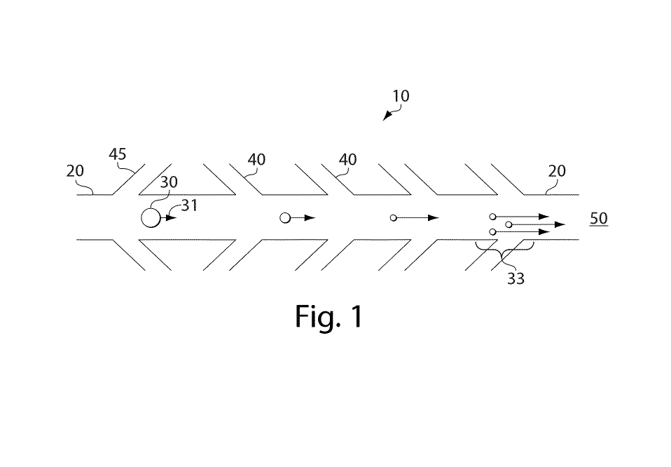

One example of an embodiment of the invention is now described with respect to FIG. 1, although other configurations may be used in other embodiments, e.g., as discussed in more detail below. In FIG. 1, microfluidic system 10 includes a microfluidic channel 20 in which fluidic droplet 30 can flow prior to being expelled from a nozzle into collection region 50, which may be heated and/or contain relatively low humidities in some cases. The microfluidic system may be formed from any suitable materials, for example, a polymer such as polydimethylsiloxane. Microfluidic channel 20 is straight in this figure, although microfluidic channel 20 need not be in other embodiments. Microfluidic channel 20 also may have a constant or a varying cross-sectional area, e.g., one that increases or decreases downstream. In addition, although only one fluidic droplet 30 is discussed here for purposes of clarity, in other embodiments, more than one fluidic droplet may be present within microfluidic channel 20.

In certain embodiments, while fluidic droplet 30 flows through microfluidic channel 20, at least some liquid from fluidic droplet 30 may evaporate. For example, if fluidic droplet 30 comprises a liquid carrying a species (e.g., suspended or dissolved therein), at least some of the liquid may evaporate from the droplet, and in certain embodiments, sufficient liquid may evaporate such that the droplet is able to solidify, e.g., to form a particle containing or even consisting essentially of the species therein. In addition, in some cases, fluidic droplet 30 may flow at relatively high velocities, in some cases reaching supersonic speeds, which may facilitate drying and evaporation of liquid from the droplet. In contrast, in many other spray-drying systems, most of the drying occurs after the fluidic droplets have been expelled from the nozzle into a drying region. In addition, in certain embodiments of the present invention, the droplet may not necessarily solidify, and still remain at least partially liquid or fluid. Furthermore, in certain embodiments, the droplet may dry to the point of supersaturation without necessarily solidifying into a particle.

In one set of embodiments, the evaporation process may be facilitated by heating microfluidic channel 20, and/or by exposing fluidic droplet 30 to a gas such as air, into which the evaporating liquid is able to evaporate into. The gas may be heated and/or dried in some cases. However, in some embodiments, the gas may not be heated; this may be useful, for example, in the drying of thermo-sensitive materials. The gas may be present in microfluidic channel 20 when fluidic droplet 30 is introduced therein, and/or the gas may be introduced into microfluidic channel 20 at one or more locations while fluidic droplet 30 flows within the channel. For instance, as is shown in FIG. 1, a plurality of side channels 40 intersect microfluidic channel 20. Side channels 40 may each intersect microfluidic channel 20 at any suitable angle (e.g., a right angle, or a non-right angle such as an acute angle, an obtuse angle, etc.), and the various side channels may each intersect at the same or different angles. For example, as is shown here, side channels 40 are positioned at about 45° (relative to the upstream direction) to allow the entering gas to assist the flow of fluidic droplet 30 within the channel. In some embodiments, the entering gas may also cause fluidic droplet 30 to accelerate within microfluidic channel 20 (as depicted by arrows 31 of increasing length within the channel), and under some conditions, such that fluidic droplet 30 is sheared or disrupted into smaller fluidic droplets, as are illustrated by droplets 33 in FIG. 1.

Also shown in this figure are optional side channels 45, which intersect microfluidic channel 20 upstream of side channels 40. In this example, side channels 45 intersect channel 20 at an angle of about 135°, although other angles (acute, right, or obtuse) are possible in other embodiments. Side channels 45, when present, may be used to introduce a gas into microfluidic channel 20 to cause a fluid entering microfluidic channel 20 to begin forming fluidic droplets 30, e.g., in the manner of a flow-focusing device. As a non-limiting example, side channels 45 may be positioned so as to cause the flow of droplets within microfluidic channel 20 to more rapidly enter the “dripping regime,” where the droplets break up to form smaller fluidic droplets 30 at essentially the same position within the channel.

The above discussion is a non-limiting example of an embodiment of the present invention that can be used to dry a fluid. However, other embodiments are also possible. For instance, some aspects of the invention are directed to systems and methods of drying or otherwise manipulating fluids in a channel such as a microfluidic channel. In certain embodiments, for example, the present invention is generally directed to a spray dryer for use in drying liquids or other fluids or materials, e.g., to produce particles or solids, or at least to promote drying. In some embodiments, the spray dryer contains an article containing one or more channels such as microfluidic channels, through which a liquid or other fluid is at least partially dried therein.

The liquid or other fluid to be dried may be present within a channel (e.g., channel 20 in FIG. 1) within the spray dryer in any suitable form, for example, as individual droplets (such as those previously discussed), as a film (e.g., coating a wall of the channel), a jet, or the like. If droplets are present, the droplets may be exhibit dripping behavior, jetting behavior, etc. In certain instances, as discussed herein, if the fluid is present as a liquid, the liquid may at least partially evaporate within the channel. Thus, for example, the liquid (or other fluid) may be relatively volatile, e.g., having a relatively high vapor pressure or partial pressure. In addition, in some cases, the liquid or other fluid may be disrupted to form droplets, which may be partially or fully dried within the channel in certain embodiments, e.g. forming particles.

Any suitable liquid may be dried. For example, the liquid may be aqueous (e.g., miscible in water), or an oil or other non-aqueous liquid (e.g., immiscible in water). Examples of aqueous liquids include, but are not limited to, water, alcohols (e.g., butanol (e.g., n-butanol), isopropanol (IPA), propanol (e.g., n-propanol), ethanol, methanol, or the like), saline solutions, blood, acids (e.g., formic acid, acetic acid, or the like), amines (e.g., dimethyl amine, diethyl amine, or the like), mixtures of these, and/or other similar fluids. It should also be understood that although liquids are described in many of the examples and embodiments below, the present invention is not limited to only liquids and methods for drying liquids, but also encompasses the drying of other fluids or materials, for example, wet or slushy solid materials, viscoelastic solids, liquid emulsions, syrupy materials, or the like, in still other embodiments of the invention. For example, a material may contain a liquid or other volatile fluid which is to be dried.

In addition, a variety of methods can be used to accelerate a fluid within a channel (e.g., present as droplets, a film, etc.), or otherwise change its velocity, in addition to the introduction of air and/or other gases into the channel, e.g., through one or more side channels as noted herein. As non-limiting examples, a second liquid or fluid may be used to accelerate the fluid, an external force may be applied to the fluid (e.g., gravitational, centripetal, etc.), or if the fluid is magnetically or electrically susceptible, the application of suitable magnetic or electric fields, respectively, may be used to accelerate the fluid within the channel, e.g., at one or more accelerator regions, which may be the same or different. Thus, as a non-limiting example, a liquid (e.g., a droplet, or a film of liquid) within a channel may be accelerated at a first accelerator region through introduction of a gas or other fluid, and accelerated at a second accelerator region through introduction of a gas or other fluid (which may be the same or different from the first accelerator region), an electric field, a magnetic field, gravity, or the like. There may be any suitable number of accelerator regions present within the device, e.g., 2, 3, 4, 5, 6, 7, 8, etc., and the acceleration techniques that are used may be the same or different.

The article can be formed, in accordance with one set of embodiments, from polymeric, flexible, and/or elastomeric polymers and/or other materials, e.g., silicone polymers such as polydimethylsiloxane (“PDMS”). In some embodiments, the article may comprise or even consist essentially of such polymers and/or other materials. Other examples of potentially suitable polymers and other materials are discussed in detail below. The article may be planar, or non-planar in some embodiments (e.g., curved). The article can be formed from a material that is at least partially mechanically deformable in some cases, e.g., such that the article can be visibly mechanically deformed by an average person without the use of tools. In other embodiments, however, the article may be formed of more relatively rigid materials such that the article is not as mechanically deformable by the average person.

As mentioned, in one set of embodiments, the channel through which a liquid or other fluid can flow may be intersected by one or more side channels. Any suitable number of side channels may be present, e.g., 1, 2, 3, 4, 5, 6, 7, 8, 9, 10, 11, 12, etc. The side channels can intersect the main channel at any suitable angle (e.g., a right angle, an acute angle, an obtuse angle, etc.), and the side channels can each intersect the main channel at the same or different angles. For example, the angle of intersection may be about 20°, about 30°, about 40°, about 45°, about 50°, about 60°, about 70°, about 80°, about 90°, about 100°, about 110°, about 120°, about 130°, about 135°, about 140°, about 150°, or about 160°. The side channels may be positioned or angled, for instance, such that gases entering the main channel from the side channels cause acceleration and/or drying of the liquid or other fluid. Thus, for example, if a plurality of side channels are present, the liquid or other fluid may be accelerated within the channel at one or more locations within the channel, e.g., due to gases entering from one or more of the side channels.

In one set of embodiments, one or more of the side channels are positioned at an acute angle relative to the main channel, which may facilitate the entry of gases into the main channel, e.g., such that the gases flow downstream in the main channel, which may be used to increase the velocity of liquids or other fluids contained within the main channel. Non-limiting examples of such side channels may be seen in FIG. 1 with side channels 40 intersecting main channel 20. In certain cases, more than one such side channel can be used. For instance, in some cases, the side channels may be positioned in pairs on either side of the main channel. This may be useful, for example, to keep the fluid within the main channel moving downstream without getting pushed to one side or the other. However, in other embodiments, the side channels may not necessarily intersect in pairs along the main channel.

Also shown in FIG. 1 are side channels 45. In one set of embodiments, such side channels may be positioned relative to the main channel such that these channels are arranged in a “flow-focusing” configuration, e.g., in which a first fluid in a first channel is sheathed or surrounded by a second fluid delivered using side channels (e.g., a second channel and sometimes a third channel or additional channels) in order to cause the first fluid to form discrete droplets contained within the second fluid. The first fluid and the second fluid can be miscible or immiscible. Channel configurations to create such discrete droplets may be found, for example, in U.S. patent application Ser. No. 11/024,228, filed Dec. 28, 2004, entitled “Method and Apparatus for Fluid Dispersion,” by Stone, et al., now U.S. Pat. No. 7,708,949, issued May 4, 2010, incorporated herein by reference in its entirety.

Unlike side channels 40, side channels 45 intersect main channel 20 at an obtuse angle in FIG. 1, rather than an acute angle. However, the angle of intersection may also be, in other embodiments, a right angle or an acute angle, e.g., as discussed above (or in some embodiments, no such side channels 45 may be present). Any such angle may be used, e.g., channel at the same or different angles. For example, the angle of intersection may be about 20°, about 30°, about 40°, about 45°, about 50°, about 60°, about 70°, about 80°, about 90°, about 100°, about 110°, about 120°, about 130°, about 135°, about 140°, about 150°, or about 160°, etc.

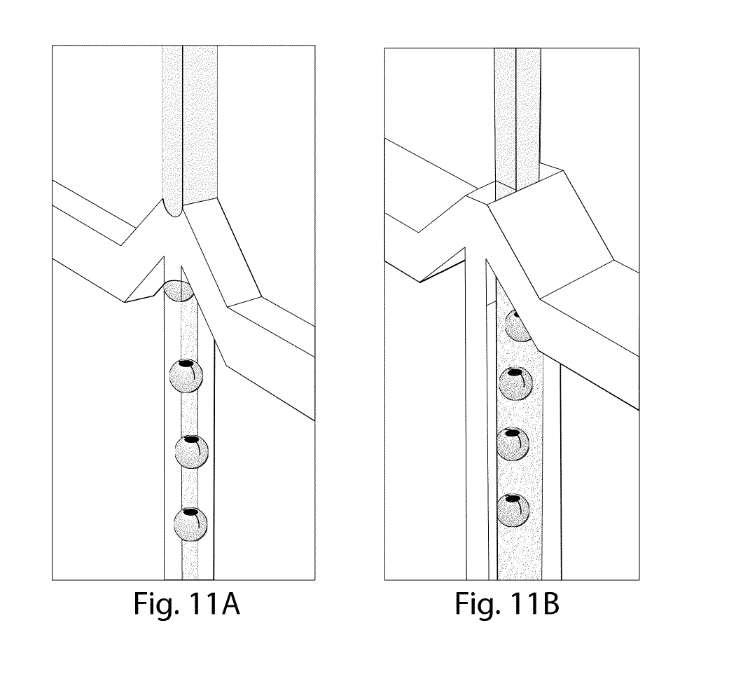

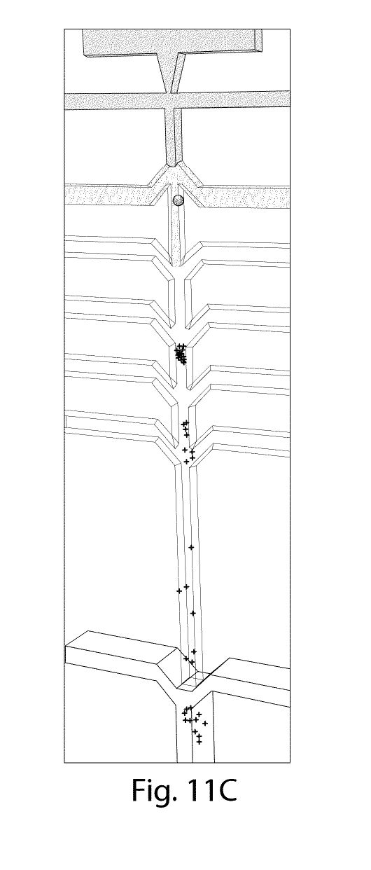

In some cases, there may be a change in the dimensions of the main channel as side channels 45 intersect, as is shown in FIG. 11B. In this figure, upon intersection of the side channels, the main channel increases in cross-sectional area. The change in area may be effected by a change in any dimension, e.g., width, length, or both, depending on the embodiment. In other cases, however, such as is shown in FIG. 11A, the main channel may not necessarily change in cross-sectional area.

In some embodiments, gases entering from a side channel may be dried and/or heated, which may facilitate drying of liquids or other fluids within the main channel. For example, the gases may be introduced to the liquids or other fluids at a temperature of at least about 40° C., at least about 50° C., at least about 60° C., at least about 70° C., at least about 80° C., at least about 90° C., etc. The gases may be introduced from one or more suitable sources. One or more than one gas may be used, e.g., introduced through one or more channels. In addition, the same or different gases may be introduced through the various side channels. In some embodiments, the entering gases may be relatively unsaturated with an evaporating liquid, thereby allowing the liquid within the channel to continue dry without saturation of the gas within the channel with evaporated liquid. The gas may be any suitable gas, for example, air, nitrogen, argon, carbon dioxide, helium, etc., as well as combinations of these and/or other gases. The gas may be at ambient pressure, or the gas may be pressurized in some instances. For instance, the pressure of the incoming gas may be at least about 0.01 bar, at least about 0.03 bar, at least about 0.05 bar, at least about 0.07 bar, at least about 0.1 bar, at least about 0.2 bar, at least about 0.3 bar, at least about 0.4 bar, at least about 0.5 bar, at least about 0.7 bar, at least about 1 bar, at least about 2 bar, at least about 3 bar, at least about 4 bar, or at least about 5 bar. In some cases, the gases are inert relative to the fluids and/or species contained therein.

In addition, in one set of embodiments, liquids or other fluids within a channel may be prevented from coming into contact with a wall of the channel, or at least a portion of the channel. In some embodiments, the liquid is prevented from coming into contact with a wall of the channel substantially throughout the length of the channel. In addition, in some cases, one or more walls or regions within the channel may be chemically treated, e.g., as discussed herein. By preventing the droplets from contacting the walls of the channel, reactions or interactions between a fluid and the walls of the channel may be reduced or eliminated. For instance, the fluid may contain a species (e.g., dissolved or suspended therein) that is able to bind to (or “foul”) a wall of the channel if the species comes into contact with the wall; by preventing, reducing, or minimizing contact between the fluid and the wall, the ability of the species to bind to the wall is reduced or eliminated. Such binding may be specific or non-specific.

In some embodiments, liquids or other fluids within a channel may be prevented from coming into contact with a wall of the channel based on the channel dimensions or geometry. For example, upon intersection of one or more side channels to the main channel, the main channel may exhibit an increase or a decrease in cross-sectional area. For instance, the main channel may exhibit a change in any dimension, e.g., width, length, or both. As a non-limiting example, in FIG. 11D, the lowermost intersection exhibits such a change in cross-sectional area. Thus, upon introduction of a liquids or other fluid through the side channels, the ability of such liquids or other fluids to contact a wall of the main channel may be reduced or eliminated.

Another aspect of the present invention is generally directed to systems and methods for accelerating a fluid within a channel, such as a microfluidic channel. This may occur in a spray dryer, or in other systems or devices (e.g., any suitable microfluidic device) in some cases, not necessarily only in spray dryers. For instance, a fluid within a channel (e.g., present as droplets, a jet, a film, etc.) may be accelerated by the entering gases, which may cause the fluid to flow faster within the channel in some embodiments, and optionally such that the fluid becomes disrupted or dispersed to form smaller droplets. Other methods of accelerating a fluid within a channel are also possible, for example, electrical or magnetic techniques.

The average velocity of the fluid within the channel may be increased by at least about 5%, at least about 10%, at least about 20%, at least about 30%, at least about 50%, at least about 75%, at least about 100%, etc., using techniques such as those described herein. In addition, even higher increases in velocity may be achieved in certain embodiments, for example, the fluid velocity may be accelerated by a factor of at least about 2 times, at least about 3 times, at least about 5 times, at least about 7 times, at least about 10 times, at least about 20 times, at least about 30 times, at least about 50 times, at least about times, at least about 70 times, at least about 100 times, at least about 200 times, at least about 300 times, at least about 500 times, at least about 700 times, at least about 1000 times, at least about 2000 times, at least about 3000 times, etc.

This increase in average velocity of the fluid can be determined relative to the average velocity of the fluid before the gas is introduced into the microfluidic channel. In some embodiments, the channel may be formed from materials that are relatively inelastic and unable to expand (although in some cases, the channel may be formed from materials that allow some expansion to occur, e.g., homogenously). Accordingly, under such conditions, the flow of the fluid within the channel may increase as gases enter the channel, e.g., at one or more locations within the channel, thereby causing the fluid to flow or move faster within the channel.

In addition, under some conditions, the increased velocity may create shear forces on the fluid, and may in some cases cause the fluid to become disrupted, thereby forming smaller droplets within the channel. For example, the forces applied to the droplets may be such that the inertial forces overcome the surface tension forces within the droplets. Smaller droplets may also facilitate drying of the fluidic droplet or evaporation of liquid, prior to being sprayed into the collection region. Thus, as a non-limiting example, a fluid droplet or film may be disrupted or dispersed to form smaller droplets by accelerating the fluid within the channel. For example, smaller droplet sizes would result in greater surface area and a smaller volume-to-area area ratio for the smaller droplets, thereby promoting additional drying.

In various embodiments, the droplets within the channel (before or after disruption), may have an average diameter of less than about 1 mm, less than about 500 micrometers, less than about 300 micrometers, less than about 200 micrometers, less than about 100 micrometers, less than about 75 micrometers, less than about 50 micrometers, less than about 30 micrometers, less than about 25 micrometers, less than about 20 micrometers, less than about 15 micrometers, less than about 10 micrometers, less than about 5 micrometers, less than about 3 micrometers, less than about 2 micrometers, less than about 1 micrometer, less than about 500 nm, less than about 300 nm, less than about 100 nm, or less than about 50 nm. The average diameter of the droplets may also be at least about 30 nm, at least about 50 nm, at least about 100 nm, at least about 300 nm, at least about 500 nm, at least about 1 micrometer, at least about 2 micrometers, at least about 3 micrometers, at least about 5 micrometers, at least about 10 micrometers, at least about 15 micrometers, or at least about 20 micrometers in certain cases. The “average diameter” of a population of droplets is the arithmetic average of the diameters of the droplets.

In some embodiments of the invention, other materials instead of and/or in addition to gases may be introduced through one or more of the side channels. Examples of other materials that may be introduced include, for example, particles (e.g., to disrupt fluids within the channel), additional fluids, other reactants (e.g., able to react with a fluid and/or species contained within a fluid), other liquids or materials for introduction into or association with the final dried solid material, or the like. For example, in one set of embodiments, excipients or other materials, such as salts, carriers, buffering agents, emulsifiers, diluents, chelating agents, fillers, drying agents, antioxidants, antimicrobials, preservatives, binding agents, bulking agents, silicas, solubilizers, or stabilizers, may be introduced.

In addition, various embodiments of the present invention are generally directed to systems and methods for at least partially drying a liquid droplet (or other fluidic droplet) within a channel such as a microfluidic channel, for example, such that at least about 10 vol % of the liquid within the droplet evaporates while the droplet is contained within the channel, prior to exiting the microfluidic channel, e.g., exiting through a nozzle into a collection region. In some embodiments, even higher amounts of drying may occur within the channel, e.g., at least about 20 vol %, at least about 30 vol %, at least about 40 vol %, at least about 50 vol %, at least about 60 vol %, at least about 70 vol %, at least about 75 vol %, at least about 80 vol %, at least about 85 vol %, at least about 90 vol %, or at least about 95 vol % of the liquid may evaporate from the droplet while the droplet is contained within the channel. As mentioned, in some embodiments, the droplets may solidify, e.g., to form particles, as liquid evaporates therefrom. For instance, a species contained within the droplets may remain to form particles as liquid evaporates. In some cases, a substantial portion of the particles may be formed from the species. The particles may form within the microfluidic channel, and/or upon expulsion of the liquid droplets into the collection region. The solid particles may be crystalline, or amorphous in certain embodiments, for example, depending on the amount of time the droplets or particles are dried and/or the speed at which the droplets dry and/or solidify to form particles. Typically the droplets form particles as the concentration of the species reaches or exceeds the saturation limit, although in some cases, the concentration may substantially exceed the saturation limit, e.g., such that supersaturation occurs, as discussed herein.

In certain embodiments, liquid droplets within a channel (e.g., prior to being expelled) may be dried to the point where the liquid becomes saturated or supersaturated with a species contained therein. In certain cases, supersaturated droplets may be expelled at a surface, e.g., of a collection chamber, and one or more particles may form upon impacting the surface. In other embodiments, however, the supersaturated droplets may solidify prior to being expelled, e.g., to form one or more particles.

Additionally, in accordance with some aspects, there may be one or more openings on nozzles in one or more of the channels that are used to expel droplets and/or particles into a collection region, or into more than one collection region in some cases. The openings can be, for instance, a simple opening or a hole in the side of a channel, an open end of a channel, or there may be an additional structure associated with the opening that the droplets and/or particles pass through before being expelled into a drying region, for example, a pipe or a tube having varying cross sectional area that can be used to direct or modify the flow of the fluid. The opening can act as a nozzle through which a droplets and/or particles can be expelled from the channel into the drying region. The opening or nozzle may have a cross-sectional aspect ratio that is the same or different from the channel. In some cases, the cross-sectional aspect ratio of the opening or nozzle may be about 1:1, at least about 1:1, at least about 2:1, at least about 3:1, at least about 4:1, at least about 5:1, at least about 6:1, at least about 7:1, at least about 8:1, at least about 10:1, at least about 12:1, at least about 15:1, or at least about 20:1. In some cases, the opening may be constructed and arranged to cause a fluid to form a spray or a mist of droplets. In other embodiments, the droplets can be expelled as a regular or steady stream of droplets and/or particles, e.g., a single file stream of droplets.

In some cases, one or more gases may be delivered to cause a fluid to break up into discrete droplets upon expulsion of the fluid into the collection region, and in some cases, such that a spray or a mist of droplets is formed. Without wishing to be bound by any theory, it is believed that fluid break-up can occur if the droplets experience forces such that the inertial forces exceed the surface tension forces, i.e., the external forces felt by the fluidic droplet exceed the inherent ability of the fluid to keep itself together as a droplet under surface tension. In many cases, the higher the acceleration felt by the droplet, the smaller the droplets that are subsequently formed after break-up. This may also accelerate solvent evaporation, since solvent evaporation is typically proportional to the exposed surface area. For example, the gas may be any of the gases described herein, and at any of the pressures described herein. The gas may be the same or different than other gases within the channel (e.g., used to cause acceleration and/or drying within the channel).

Thus, the droplets and/or particles formed from solidifying droplets (completely or partially solidified) may then be sprayed (or spray-dried), or otherwise expelled, into a suitable collection region. The collection region may be open, e.g., open to the atmosphere, or closed, for example, partially or completely surrounded by a chamber into which the droplets and/or particles are expelled. For example, a collection chamber can be formed of glass, plastic, or any other suitable material which can be used to at least partially contain or enclose a suitable drying gas for drying fluids expelled into the collection region. The collection region may have any suitable volume. The drying gas may be air, nitrogen, carbon dioxide, argon, or other suitable gases. In some embodiments, the gas is chosen so as to be relatively inert or unreactive to the expelled fluids or other materials; however, in other embodiments, the gas may react with one or more of the expelled fluids or other materials. The drying gas can also be dehumidified using various techniques, for example, refrigeration or condensing cycles, electronic methods (e.g., Peltier heat pumps), desiccants (e.g., phosphorus pentoxide), or hygroscopic materials. In some embodiments, the relative humidity within the collection region is no more than about 50%, no more than about 40%, no more than about 35%, no more than about 30%, no more than about 25%, no more than about 20%, no more than about 15%, no more than about 10%, or no more than about 5%. Other techniques for controlling the relative humidity of a region will be known to those of ordinary skill in the art.

In some cases, the collection region is heated, e.g., using one or more heaters. The temperature of the collection region may be chosen, for example, to allow partial or complete drying of the expelled fluids or other materials to occur (depending on the application), in some cases without causing adverse degradation or reaction with the expelled fluids or other materials. For example, the heater may be used to heat the collection region to a temperature of at least about 30° C., at least about 40° C., at least about 60° C., at least about 80° C., at least about 100° C., at least about 125° C., at least about 150° C., at least about 200° C., at least about 300° C., at least about 400° C., at least about 500° C., etc. Any suitable method may be used to heat the collection region. For example, the collection region may be heated using induction heating, burning of a fuel, exposure to radiation (e.g., infrared radiation), chemical reaction, or the like.

In some cases, a population of droplets is formed upon expulsion of fluids from the channel into the collection region. The average diameter of this population may or may not necessarily be the same as the average droplets within the channel, prior to being expelled into the collection region. Those of ordinary skill in the art will be able to determine the average diameter of a population of droplets, for example, using laser light scattering or other known techniques. The droplets so formed can be spherical, or non-spherical in certain cases. The diameter of a droplet, in a non-spherical droplet, may be taken as the diameter of a perfect mathematical sphere having the same volume as the non-spherical droplet. The droplets may be formed steadily, for example, forming a steady or linear stream of droplets, or in other embodiments, larger numbers of droplets may be formed, for example, creating a mist or a spray of individual droplets, e.g., within the collection region.

In some cases, as previously discussed, liquid may evaporate from the droplets, which may cause the average diameter of the droplets to decrease in some embodiments. In certain embodiments, as non-limiting examples, the average diameter of the droplets can be less than about 1 mm, less than about 500 micrometers, less than about 300 micrometers, less than about 200 micrometers, less than about 100 micrometers, less than about 75 micrometers, less than about 50 micrometers, less than about 30 micrometers, less than about 25 micrometers, less than about 20 micrometers, less than about 15 micrometers, less than about 10 micrometers, less than about 5 micrometers, less than about 3 micrometers, less than about 2 micrometers, less than about 1 micrometer, less than about 500 nm, less than about 300 nm, less than about 100 nm, or less than about 50 nm. The average diameter of the droplets may also be at least about 30 nm, at least about 50 nm, at least about 100 nm, at least about 300 nm, at least about 500 nm, at least about 1 micrometer, at least about 2 micrometers, at least about 3 micrometers, at least about 5 micrometers, at least about 10 micrometers, at least about 15 micrometers, or at least about 20 micrometers in certain cases.

In certain embodiments, the fluidic droplets within the collection region, e.g., after being expelled from a channel, may be substantially monodisperse. For example, the fluidic droplets may have a distribution in diameters such that no more than about 5%, no more than about 2%, or no more than about 1% of the droplets have a diameter less than about 90% (or less than about 95%, or less than about 99%) and/or greater than about 110% (or greater than about 105%, or greater than about 101%) of the overall average diameter of the plurality of droplets. However, in other embodiments, the fluidic droplets within the collection region are polydisperse.

In some cases, at least a portion of the fluids within the individual droplets may harden or solidify, e.g., within the collection region and/or within a microfluidic channel. For example, some of the droplets, and/or a portion of some of the droplets, can harden to form particles. The particles can then be subsequently collected. The particles may, in some embodiments, have substantially the same shape and/or be substantially the same size as the fluidic droplets. For example, the particles can be monodisperse, e.g., as discussed above, and/or the particles may be spherical, or non-spherical in certain cases. In some cases, some or all of the particles may be microparticles and/or nanoparticles. Microparticles generally have an average diameter of less than about 1 mm (e.g., such that the average diameter of the particles is typically measured in micrometers), while nanoparticles generally have an average diameter of less than about 1 micrometer (e.g., such that the average diameter of the particles is typically measured in nanometers). In some cases, the nanoparticles may have an average diameter of less than about 100 nm. In some cases, the particles may have a distribution in diameters such that at least about 50%, at least about 60%, at least about 70%, about 80%, at least about 85%, at least about 90%, at least about 95%, at least about 97%, or at least about 99% of the droplets have a diameter that is no more than about 10% different, no more than about 7% different, no more than about 5% different, no more than about 4% different, no more than about 3% different, no more than about 2% different, or no more than about 1% different from the average diameter of the particles.

In one set of embodiments, the average diameter of the particles is less than about 1 mm, less than about 500 micrometers, less than about 300 micrometers, less than about 200 micrometers, less than about 100 micrometers, less than about 75 micrometers, less than about 50 micrometers, less than about 30 micrometers, less than about 25 micrometers, less than about 20 micrometers, less than about 15 micrometers, less than about 10 micrometers, less than about 5 micrometers, less than about 3 micrometers, less than about 2 micrometers, less than about 1 micrometer, less than about 500 nm, less than about 300 nm, less than about 100 nm, or less than about 50 nm. The average diameter of the particles may also be at least about 30 nm, at least about 50 nm, at least about 100 nm, at least about 300 nm, at least about 500 nm, at least about 1 micrometer, at least about 2 micrometers, at least about 3 micrometers, at least about 5 micrometers, at least about 10 micrometers, at least about 15 micrometers, or at least about 20 micrometers in certain cases.

In some aspects, a fluid within a channel may contain a species such as a chemical, biochemical, or biological entity, a cell, a particle, a bead, gases, molecules, a pharmaceutical agent, a drug, DNA, RNA, proteins, a fragrance, a reactive agent, a biocide, a fungicide, a pesticide, a preservative, or the like. Thus, the species can be any substance that can be contained in a fluid and can be differentiated from the fluid containing the species. For example, the species may be dissolved or suspended in the fluid. The species may be present in one or more of the fluids. If the fluids contain droplets, the species can be present in some or all of the droplets. Additional non-limiting examples of species that may be present include, for example, biochemical species such as nucleic acids such as siRNA, RNAi and DNA, proteins, peptides, or enzymes. Still other examples of species include, but are not limited to, nanoparticles, quantum dots, fragrances, proteins, indicators, dyes, fluorescent species, chemicals, or the like. As yet another example, the species may be a drug, pharmaceutical agent, or other species that has a physiological effect when ingested or otherwise introduced into the body, e.g., to treat a disease, relieve a symptom, or the like. In some embodiments, the drug may be a small-molecule drug, e.g., having a molecular weight of less than about 1000 Da or less than about 2000 Da.

Other aspects of the present invention include the following. Certain embodiments of the present invention present a versatile tool, e.g., for the development of new formulations. For example, small quantities of a drug, pharmaceutical agent, or other species (e.g., as discussed herein) can be tested in some cases. In certain embodiments, for instance, a drug, pharmaceutical agent, or other species may be tested for its spray drying characteristics relatively rapidly, and/or without requiring a large initial amount of sample for testing purposes. Conditions for spray drying may be changed relatively rapidly, e.g., before and/or during spray drying experiments, in order to experiment or optimize various formulations, and in some cases without requiring a relatively large amount of drug, pharmaceutical agent, or other species. For instance, no more than about 100 g, no more than about 50 g, no more than about 30 g, no more than about 10 g, no more than about 5 g, no more than about 3 g, no more than about 1 g, no more than about 500 mg, no more than about 300 mg, or no more than about 100 mg of drug, pharmaceutical agent, or other species may be used in the spray dryer in certain embodiments, e.g., to produce particles. In some cases, relatively small numbers or masses of particles may be produced in a given spray drying experiment, e.g., allowing conditions to be rapidly changed, for example, as discussed above. For instance, no more than about 100 g, no more than about 50 g, no more than about 30 g, no more than about 10 g, no more than about 5 g, no more than about 3 g, no more than about 1 g, no more than about 500 mg, no more than about 300 mg, or no more than about 100 mg of particles or solids may be formed using the spray dryer. In some cases, the composition of the particles may be easily controlled, e.g., by controlling fluid flow into the spray dryer, and/or by joining two or more different fluid streams containing different dissolved substances into one, e.g., just before droplet formation.

In addition, in some embodiments, a spray dryer as discussed herein may have a relatively low dead volume, which may thus reduce waste of sample and/or facilitate experiments that use minimal amounts of drugs, pharmaceutical agents, or other species. The dead volume of the spray dryer includes volumes within the spray dryer which contain volumes of fluid that are not able to be expelled by the spray dryer into the drying region during normal operation of the spray dryer.

In some cases, a suspension may be produced using spray dryers such as those discussed herein. Such suspensions may be used, for example, to enhance the dissolution rate and bioavailability of hydrophobic drugs. For instance, a suspension can be prepared by spraying a fluid into a carrier liquid. In some embodiments, the carrier liquid may contain a stabilizer or a surfactant, e.g., as in a solution. In other embodiments, however, no stabilizer or surfactant may be present in the carrier liquid. In some cases, the fluid being expelled may be dried sufficiently to produce particles prior to contacting the carrier liquid; in other cases, however, the fluids may enter the solution not fully dried, for example, to form a liquid suspension in the carrier liquid.

In addition, in some embodiments, a spray dryer may be directly connected to a vial, a sample holder, an ampoule, etc., without necessarily requiring intermediate processing and/or storage, for example, fluid transport or filling from a collection chamber to a vial, which can cause waste, alteration of physical or chemical properties, etc. For example, one or more relatively small vials (or other collection chambers) may be used to directly collect material produced by the spray dryer. The vial or other collection chamber may have a relatively small volume, e.g., less than about 100 ml, less than about 50 ml, less than about 30 ml, less than about 20 ml, less than about 15 ml, less than about 10 ml, less than about 5 ml, etc. In some cases, one collection chamber is used, although in other cases, more than one may be used, e.g., such that one is replaced by the next (manually or automatically) after a certain time and/or after a certain amount has been collected therein.

As mentioned, in various aspects of the invention, liquid droplets may pass through channels, and gases may also be introduced into the channel through side channels. The main channel and the side channels may be the same size or different, and one or both may be microfluidic channels. These channels may be relatively straight, e.g., as is depicted in FIG. 1, or one or more of the channels may be bent, curved, wiggly, etc., depending on the application. In various embodiments, the channels may exhibit a constant cross-sectional shape or area, or one that varies, e.g., one that increases or decreases in area downstream. In addition, there can be any number of channels present within an article, and the channels may be arranged in any suitable configuration. The channels may be all interconnected, or there can be more than one network of channels present.

Thus, as a non-limiting example, FIG. 1 illustrates a first (main) channel, and second, third, fourth, fifth, sixth, seventh, eighth, ninth, tenth, and eleventh side channels intersecting the first channel at various intersections, i.e., second and third channels at a first intersection, fourth and fifth channels at a second intersection, sixth and seventh channels at a third intersection, eighth and ninth channels at a fourth intersection, and tenth and eleventh channels at a fifth intersection. As previously mentioned, this is by way of illustration only, and in other embodiments of there may be more or few side channels present, and their configuration (e.g., angle of intersection, orientation, numbers present at an intersection, etc.) may vary.

Fluids (e.g., liquids, gases, etc., such as those described herein) may be delivered into channels such as those described above from one or more fluid sources. Any suitable source of fluid can be used, and in some cases, more than one source of fluid is used. For example, a pump, gravity, capillary action, surface tension, electroosmosis, centrifugal forces, etc. may be used to deliver a fluid from a fluid source into one or more channels in the article. Non-limiting examples of pumps include syringe pumps, peristaltic pumps, pressurized fluid sources, or the like. The article can have any number of fluid sources associated with it, for example, 1, 2, 3, 4, 5, 6, 7, 8, 9, 10, etc., or more fluid sources. The fluid sources need not be used to deliver fluid into the same channel, e.g., a first fluid source can deliver a first fluid to a first channel while a second fluid source can deliver a second fluid to a second channel, etc.

In some embodiments, the fluids flow through the channel at relatively high flow rates or speeds, for example. The flow within the channels can be laminar or turbulent. In some cases, flow through the channel occurs such that the Reynolds number of the flow is at least about 0.001, at least about 0.003, at least about 0.005, at least about 0.01, at least about 0.03, at least about 0.05, at least about 0.1, at least about 0.3, or at least about 0.5. Higher Reynolds numbers may be used in other embodiments (e.g., corresponding to turbulent flow), for instance, Reynolds numbers of at least about 1, at least about 3, at least about 5, at least about 10, at least about 30, at least about 50, at least about 100, at least about 300, at least about 500, or at least about 1000. In still other embodiments, however, flow through the channel may occur such that the Reynolds number of the flow is less than 1000, less than about 300, less than about 100, less than about 30, less than about 10, less than about 3, or less than about 1. In yet other embodiments of the invention, the volumetric flow rate of fluid through the channel may be at least about 0.01 ml/h at least about 0.03 ml/h, at least about 0.05 ml/h, at least about 0.1 ml/h, at least about 0.3 ml/h, at least about 0.5 ml/h, at least about 1 ml/h, at least about 3 ml/h, at least about 5 ml/h, at least about 10 m/1, at least about 30 ml/h, at least about 50 ml/h, or at least about 100 ml/h.

Relatively high flow rates may be achieved, for example, by increasing or controlling the difference in pressure between one or more of the fluid sources within the article containing channels, and the pressure within the drying region of the spray dryer, and/or through parallelization. For example, the pressure within the drying region may be at ambient pressure (approximately 1 atm), and/or the pressure may be higher or lower. As specific non-limiting examples, the pressure within the drying region may be less than about 50 mmHg, less than about 100 mmHg, less than about 150 mmHg, less than about 200 mmHg, less than about 250 mmHg, less than about 300 mmHg, less than about 350 mmHg, less than about 400 mmHg, less than about 450 mmHg, less than about 500 mmHg, at least 550 mmHg, at least 600 mmHg, at least 650 mmHg, less than about 700 mmHg, or less than about 750 mmHg below atmospheric pressure. As another example, the pressure of one or more of the fluid sources within the article may be at least about 1 bar, at least about 1.1 bars, at least about 1.2 bars, at least about 1.3 bars, at least about 1.4 bars, at least about 1.5 bars, at least about 1.7 bars, at least about 2 bars, at least about 2.5 bars, at least about 3 bars, at least about 4 bars, at least about 5 bars, etc.

In some embodiments, at least some of the channels within the article are microfluidic channels. “Microfluidic,” as used herein, refers to a device, article, or system including at least one fluid channel having a cross-sectional dimension of less than about 1 mm. The “cross-sectional dimension” of the channel is measured perpendicular to the direction of net fluid flow within the channel. Thus, for example, some or all of the fluid channels in an article can have a maximum cross-sectional dimension less than about 2 mm, and in certain cases, less than about 1 mm. In one set of embodiments, all fluid channels in an article are microfluidic and/or have a largest cross sectional dimension of no more than about 2 mm or about 1 mm. In certain embodiments, the fluid channels may be formed in part by a single component (e.g. an etched substrate or molded unit). Of course, larger channels, tubes, chambers, reservoirs, etc. can be used to store fluids and/or deliver fluids to various elements or systems in other embodiments of the invention. In one set of embodiments, the maximum cross-sectional dimension of the channels in an article is less than about 1 mm, less than about 500 micrometers, less than about 300 micrometers, less than about 200 micrometers, less than about 100 micrometers, less than about 75 micrometers, less than about 50 micrometers, less than about 30 micrometers, less than about 25 micrometers, less than about 20 micrometers, less than about 15 micrometers, less than about 10 micrometers, less than about 5 micrometers, less than about 3 micrometers, less than about 2 micrometers, less than about 1 micrometer, less than about 500 nm, less than about 300 nm, less than about 100 nm, or less than about 50 nm.

A channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlets and/or outlets or openings. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to net fluid flow of less than about 5 mm or 2 mm, or less than about 1 mm, less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases, the dimensions of the channel are chosen such that fluid is able to freely flow through the article or substrate. The dimensions of the channel may also be chosen, for example, to allow a certain volumetric or linear flow rate of fluid in the channel. Of course, the number of channels and the shape of the channels can be varied by any method known to those of ordinary skill in the art. In some cases, more than one channel may be used. For example, two or more channels may be used, where they are positioned adjacent or proximate to each other, positioned to intersect with each other, etc.

In one set of embodiments, the channels within the article are arranged in a quasi-2-dimensional pattern. In a “quasi-2-dimensional pattern,” the channels within the article are constructed and arranged such that at least one plane can be defined relative to the article such that, when all of the channels within the article are “shadowed” or perpendicularly projected onto the plane, any two channels that appear to be fluidically connected are, in fact, fluidically connected (i.e., there are no “bridges” within the article separating those fluids in separate channels). Such articles are useful in certain cases, for example, due to their ease of manufacturing, creation, or preparation.

In certain embodiments, one or more of the channels within the article may have an average cross-sectional dimension of less than about 10 cm. In certain instances, the average cross-sectional dimension of the channel is less than about 5 cm, less than about 3 cm, less than about 1 cm, less than about 5 mm, less than about 3 mm, less than about 1 mm, less than 500 micrometers, less than 200 micrometers, less than 100 micrometers, less than 50 micrometers, or less than 25 micrometers. The “average cross-sectional dimension” is measured in a plane perpendicular to net fluid flow within the channel. If the channel is non-circular, the average cross-sectional dimension may be taken as the diameter of a circle having the same area as the cross-sectional area of the channel. Thus, the channel may have any suitable cross-sectional shape, for example, circular, oval, triangular, irregular, square, rectangular, quadrilateral, or the like. In some embodiments, the channels are sized so as to allow laminar flow of one or more fluids contained within the channel to occur.

The channel may also have any suitable cross-sectional aspect ratio. The “cross-sectional aspect ratio” is, for the cross-sectional shape of a channel, the largest possible ratio (large to small) of two measurements made orthogonal to each other on the cross-sectional shape. For example, the channel may have a cross-sectional aspect ratio of less than about 2:1, less than about 1.5:1, or in some cases about 1:1 (e.g., for a circular or a square cross-sectional shape). In other embodiments, the cross-sectional aspect ratio may be relatively large. For example, the cross-sectional aspect ratio may be at least about 2:1, at least about 3:1, at least about 4:1, at least about 5:1, at least about 6:1, at least about 7:1, at least about 8:1, at least about 10:1, at least about 12:1, at least about 15:1, or at least about 20:1. Relatively large cross-sectional aspect ratios are useful in accordance with some embodiments, as is discussed herein, for preventing or minimizing contact between a fluid within a channel and one or more walls within the channel.

As mentioned, the channels can be arranged in any suitable configuration within the article. Different channel arrangements may be used, for example, to manipulate fluids, droplets, and/or other species within the channels. For example, channels within the article can be arranged to create droplets (e.g., discrete droplets, single emulsions, double emulsions or other multiple emulsions, etc.), to mix fluids and/or droplets or other species contained therein, to screen or sort fluids and/or droplets or other species contained therein, to split or divide fluids and/or droplets, to cause a reaction to occur (e.g., between two fluids, between a species carried by a first fluid and a second fluid, or between two species carried by two fluids to occur), or the like. As a specific non-limiting example, two or more channels can be arranged to cause “flow-focusing” of different fluids within the channels to form droplets.

In some cases, there are a relatively large number and/or a relatively large length of channels present in the article. For example, in some embodiments, the channels within an article, when added together, can have a total length of at least about 100 micrometers, at least about 300 micrometers, at least about 500 micrometers, at least about 1 mm, at least about 3 mm, at least about 5 mm, at least about 10 mm, at least about 30 mm, at least 50 mm, at least about 100 mm, at least about 300 mm, at least about 500 mm, at least about 1 m, at least about 2 m, or at least about 3 m in some cases. As another example, an article can have at least 1 channel, at least 3 channels, at least 5 channels, at least 10 channels, at least 20 channels, at least 30 channels, at least 40 channels, at least 50 channels, at least 70 channels, at least 100 channels, etc.

The channel may also be coated in some embodiments. For example, the coating may render the walls (or a portion thereof) of the channel more hydrophobic or more hydrophilic, depending on the application. As a specific non-limiting example, a fluid may be relatively hydrophilic and the channel walls may be relatively hydrophobic, and/or coated to render the walls more hydrophobic, such that the fluid is generally repelled (does not wet) the walls of the channel, thereby assisting in preventing the fluid from contacting the hydrophobic walls defining the fluidic channel. Such a configuration may be useful, for instance, for droplet formation. In some embodiments, for example, for film formation, the channel walls may be chosen to be relatively hydrophilic (e.g., for a relatively hydrophilic fluid) or relatively hydrophobic (e.g., for a relatively hydrophobic fluid).

As yet another example, the fluid may be relatively hydrophobic and the channel walls may be relatively hydrophilic. Typically, a “hydrophilic” material or surface is one that wets water, e.g., water on such a surface has a contact angle of less than 90°, while a “hydrophobic” material or surface has a contact angle of greater than 90°. However, hydrophobicity may also be determined in other embodiments in a relative sense, i.e., a first material may be more hydrophilic than a second material (e.g., have a smaller contact angle), although the materials may both be hydrophilic or both be hydrophobic. Any suitable method may be used to coat or treat the walls (or a portion thereof) of a channel. For instance, a wall can be treated with oxygen plasma treatment, or coated with a sol-gel material, a silane, a polyelectrolyte, etc. that can be used to alter the hydrophobicity of the wall. A portion of the sol-gel may be exposed to light, such as ultraviolet light, which can be used to induce a chemical reaction in the sol-gel that alters its hydrophobicity. The sol-gel can include a photoinitiator which, upon exposure to light, produces radicals. Optionally, the photoinitiator is conjugated to a silane or other material within the sol-gel. The radicals so produced may be used to cause a condensation or polymerization reaction to occur on the surface of the sol-gel, thus altering the hydrophobicity of the surface. As another non-limiting example, a metal oxide may be coated onto a wall to alter its hydrophobicity. Still other examples are disclosed below, and in International Patent Application No. PCT/US2009/000850, filed Feb. 11, 2009, entitled “Surfaces, Including Microfluidic Channels, With Controlled Wetting Properties,” by Abate, et al., published as WO 2009/120254 on Oct. 1, 2009, and U.S. patent application Ser. No. 12/733,086, filed Feb. 5, 2010, entitled “Metal Oxide Coating on Surfaces,” by Weitz, et al., published as U.S. Patent Application Publication No. 2010/0239824 on Sep. 23, 2010, each of which is incorporated herein by reference in its entirety.

Non-limiting examples of systems for manipulating fluids, droplets, and/or other species are discussed below. Additional examples of suitable manipulation systems can also be seen in U.S. patent application Ser. No. 11/246,911, filed Oct. 7, 2005, entitled “Formation and Control of Fluidic Species,” by Link, et al., published as U.S. Patent Application Publication No. 2006/0163385 on Jul. 27, 2006; U.S. patent application Ser. No. 11/024,228, filed Dec. 28, 2004, entitled “Method and Apparatus for Fluid Dispersion,” by Stone, et al., now U.S. Pat. No. 7,708,949, issued May 4, 2010; U.S. patent application Ser. No. 11/885,306, filed Aug. 29, 2007, entitled “Method and Apparatus for Forming Multiple Emulsions,” by Weitz, et al., published as U.S. Patent Application Publication No. 2009/0131543 on May 21, 2009; and U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007; each of which is incorporated herein by reference in its entirety.

A variety of materials and methods, according to certain aspects of the invention, can be used to form articles or components such as those described herein, e.g., channels such as microfluidic channels, chambers, etc. For example, various articles or components can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al).

In one set of embodiments, various structures or components of the articles described herein can be formed of a polymer, for example, an elastomeric polymer such as polydimethylsiloxane (“PDMS”), polytetrafluoroethylene (“PTFE” or Teflon®), or the like. For instance, according to one embodiment, a microfluidic channel may be implemented by fabricating the fluidic system separately using PDMS or other soft lithography techniques (details of soft lithography techniques suitable for this embodiment are discussed in the references entitled “Soft Lithography,” by Younan Xia and George M. Whitesides, published in the Annual Review of Material Science, 1998, Vol. 28, pages 153-184, and “Soft Lithography in Biology and Biochemistry,” by George M. Whitesides, Emanuele Ostuni, Shuichi Takayama, Xingyu Jiang and Donald E. Ingber, published in the Annual Review of Biomedical Engineering, 2001, Vol. 3, pages 335-373; each of these references is incorporated herein by reference).

Other examples of potentially suitable polymers include, but are not limited to, polyethylene terephthalate (PET), polyacrylate, polymethacrylate, polycarbonate, polystyrene, polyethylene, polypropylene, polyvinylchloride, cyclic olefin copolymer (COC), polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like. Combinations, copolymers, or blends involving polymers including those described above are also envisioned. The device may also be formed from composite materials, for example, a composite of a polymer and a semiconductor material.

In some embodiments, various structures or components of the article are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, waxes, metals, or mixtures or composites thereof heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, dodecyltrichlorosilanes, etc.

Silicone polymers are used in certain embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of various structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour, about 3 hours, about 12 hours, etc. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures or channels from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, structures can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable or bonded to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

Thus, in certain embodiments, the design and/or fabrication of the article may be relatively simple, e.g., by using relatively well-known soft lithography and other techniques such as those described herein. In addition, in some embodiments, rapid and/or customized design of the article is possible, for example, in terms of geometry. In one set of embodiments, the article may be produced to be disposable, for example, in embodiments where the article is used with substances that are radioactive, toxic, poisonous, reactive, biohazardous, etc., and/or where the profile of the substance (e.g., the toxicology profile, the radioactivity profile, etc.) is unknown. Another advantage to forming channels or other structures (or interior, fluid-contacting surfaces) from oxidized silicone polymers is that these surfaces can be much more hydrophilic than the surfaces of typical elastomeric polymers (where a hydrophilic interior surface is desired). Such hydrophilic channel surfaces can thus be more easily filled and wetted with aqueous solutions than can structures comprised of typical, unoxidized elastomeric polymers or other hydrophobic materials.

Certain aspects of the invention are generally directed to techniques for scaling up or “numbering up” devices such as those discussed herein. For example, in one set of embodiments, a channel can have more than one opening or nozzle, which may be used to expel a plurality of droplets or particles into a collection region or into more than one collection region. As another example, an article may contain more than one channel, which may be used to expel a plurality of droplets or particles into a collection region or into more than one collection region. For instance, an article can contain at least 2 channels, at least 3 channels, at least 5 channels, at least 10 channels, at least 25 channels, at least 50 channels, at least 100 channels, some or all of which channels may have on or more openings or nozzles. As yet another example, more than one article may be present, some or all of which may have at least one opening through which droplets or particles are expelled, for instance, into a collection region or into more than one collection region. For example, multiple articles may positioned next to each other, and they may be connected via one or more distribution channels. In some cases, some or all of the articles may share one or more common sources of fluid (e.g., liquids, gases, etc.), such as those described herein. As still another example, combinations of any of these may be present.

If more than one article is present, the articles may independently be substantially the same or different. In some embodiments, for instance, greater production of droplets or particles can be achieved simply by adding additional substantially identical copies of the articles used to produce the droplets or particles. For example, a spray dryer may contain at least 2 articles, at least 3 articles, at least 5 articles, at least 10 articles, at least 25 articles, at least 50 articles, at least 100 articles, at least 250 articles, at least 500 articles, at least 1000 articles, etc., which may be used to expel a plurality of droplets or particles into a collection region or into more than one collection region. The articles can draw fluids from a common fluid source or more than one common fluid source in some embodiments. In certain embodiments, for example, each article can have its own fluid source.

Those of ordinary skill in the art will be aware of other techniques useful for scaling up or numbering up devices or articles such as those discussed herein. For example, in some embodiments, a fluid distributor can be used to distribute fluid from one or more inputs to a plurality of outputs, e.g., in one more devices. For instance, a plurality of articles may be connected in three dimensions. In some cases, channel dimensions are chosen that allow pressure variations within parallel devices to be substantially reduced. Other examples of suitable techniques include, but are not limited to, those disclosed in International Patent Application No. PCT/US2010/000753, filed Mar. 12, 2010, entitled “Scale-up of Microfluidic Devices,” by Romanowsky, et al., published as WO 2010/104597 on Nov. 16, 2010, incorporated herein by reference in its entirety.

The following documents are incorporated herein by reference in their entireties: U.S. patent application Ser. No. 11/246,911, filed Oct. 7, 2005, entitled “Formation and Control of Fluidic Species,” by Link, et al., published as U.S. Patent Application Publication No. 2006/0163385 on Jul. 27, 2006; U.S. patent application Ser. No. 11/024,228, filed Dec. 28, 2004, entitled “Method and Apparatus for Fluid Dispersion,” by Stone, et al., now U.S. Pat. No. 7,708,949, issued May 4, 2010; U.S. patent application Ser. No. 11/885,306, filed Aug. 29, 2007, entitled “Method and Apparatus for Forming Multiple Emulsions,” by Weitz, et al., published as U.S. Patent Application Publication No. 2009/0131543 on May 21, 2009; U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007; and International Patent Application No. PCT/US2011/001993, filed Dec. 20, 2011, entitled “Spray Drying Techniques,” by Abate, et al., each of which is incorporated herein by reference in its entirety.

The following examples are intended to illustrate certain embodiments of the present invention, but do not exemplify the full scope of the invention.

### Example 1

The poor water solubility of many newly developed drugs and nutrition supplements limits their bioavailability and therefore effectiveness as medication. The dissolution rate of hydrophobic moieties generally increases with decreasing particle size. It is therefore often beneficial to formulate poorly water soluble active substances as nanoparticles if they are intended for applications that require fast dissolution rates.

The size of active particles can often be tuned using various formulations. Spray drying is an often-used method to formulate drug particles for oral administration and inhalation due to its high throughput and cost effectiveness. Commercial spray driers typically include a nozzle where a solvent containing dissolved actives is atomized, a drying chamber where the solvent is evaporated under a steady air flow, and a collection chamber that can optionally be electrostatically charged to increase the yield of spray dried particles.

During the spray drying process, active nanoparticles nucleate and grow inside droplets in the drying chamber. The concentration of actives inside droplets steadily increases during solvent evaporation that occurs in the drying chamber. When the active concentration reaches the saturation concentration, actives start to nucleate and grow. Particles grow until the solvent is completely evaporated. Thus, the particle size decreases with increasing solvent evaporation rates as the nanoparticle growth time is directly proportional to the solvent evaporation rate. Particles formulated using commercially available spray driers typically are 500 nm to several micrometrs in diameter.

To decrease the size of spray dried particles, solvent evaporation rates are often increased by blowing pre-heated air into the evaporation chamber. However, the use of hot air introduces the risk of thermal degradation of thermosensitive substances during the formulation process. Alternatively, the evaporation rate can be increased by decreasing the size of droplets generated at the nozzle of the spray drier; this results in a higher surface-to-volume ratio of the droplets which accelerates solvent evaporation. The drop size in conventional spray driers is determined by the nozzle design and the liquid properties; for commercial spray drier, drop sizes range from 30 micrometers to several hundred micrometers.

These examples illustrate a PDMS (polydimethylsiloxane) based microfluidic spray drier, a “nebulator,” that forms droplets within the device. Droplets are accelerated by the high velocity of the air flow that is used as a continuous phase. The high air flow rates may also lead to a further break-up of the primary droplets into smaller secondary droplets downstream the microfluidic channel. The high surface-to-volume ratio of these secondary droplets and the high convection caused by the supersonic air flow may lead to high solvent evaporation rates. The microfluidic nebulator, as shown in this example, can be used to produce non-agglomerated, amorphous hydrophobic drug and CaCO₃ nanoparticles with diameters below 30 nm.

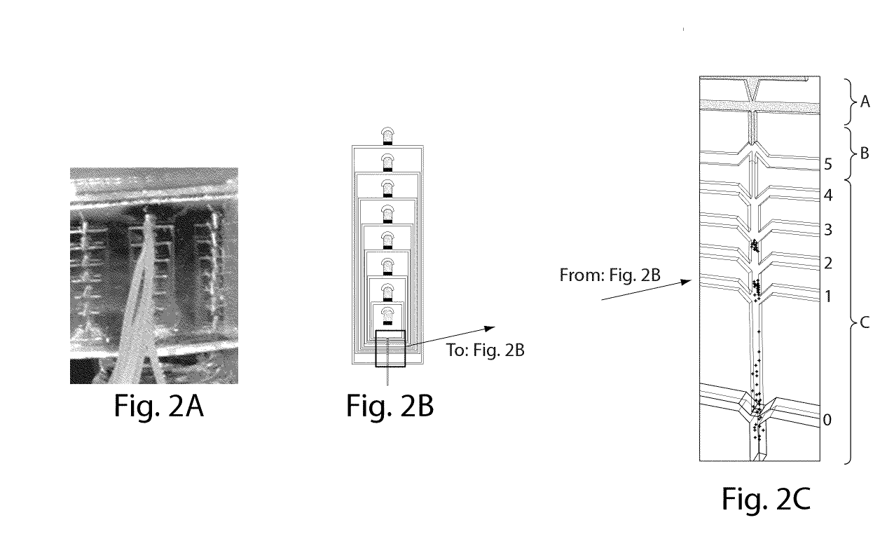

The nebulator used in this example was formed from a microfluidic PDMS device. It can be divided into three sections: (A) a liquid mixing unit where different solutions are mixed on chip, (B) followed by a nebulization unit where thin liquid films or droplets are generated, and (C) an evaporation unit where droplets are accelerated and solvents partially evaporated before they reach the device outlet (FIG. 2). The microfluidic nebulator was produced using soft lithography. To ensure a homogeneous pressure-driven expansion of all channel walls, the PDMS devices were bonded to PDMS substrates. The device nozzle was formed by slicing the device outlet with a razor blade. The PDMS channel surfaces were treated with dodecyltrichlorosilanes to render them hydrophobic. During operation, air was supplied to the nebulator through a gas regulator, and the dispersed liquid phase was fed into the microfluidic nebulator using volume controlled peristaltic pumps.

FIG. 2 shows the set-up of the microfluidic nebulator used in these examples. FIG. 2A shows the microfluidic nebulator. Air and a liquid were used as a continuous and dispersed phase, respectively. They were injected into the microfluidic device using polyethylene tubing. FIG. 2B shows an overview and FIG. 2C shows a close-up schematic of the design of the microfluidic nebulator.

### Example 2

To show the versatility of the microfluidic nebulator, in this example, inorganic CaCO₃ nanoparticles were produced, an aqueous reaction was demonstrated, and organic fenofibrate nanoparticles were formulated in a system based on organic solvents, as is discussed as follows. CaCO₃ particles can be used as Ca²⁺ source in nutrition supplements, while fenofibrate is a poorly water soluble drug that lowers the level of triglycerides, low-density, very low density lipoproteins and increases the concentration of high-density lipoproteins in the blood.

CaCO₃ nanoparticles were synthesized by co-injecting two aqueous solutions containing 5 mM CaCl₂ and Na₂CO₃, respectively, at a rate of 2×1 ml/h into the nebulator. Dry CaCO₃ nanoparticles were collected 20 cm apart from the outlet of the microfluidic nebulator. Fenofibrate was dissolved in ethanol and injected into the nebulator at a rate of 1 ml/h. Dry fenofibrate nanoparticles were collected 10 cm apart from the device outlet. Unless stated otherwise, the pressure applied to the air inlets was set to 2.8 bar.

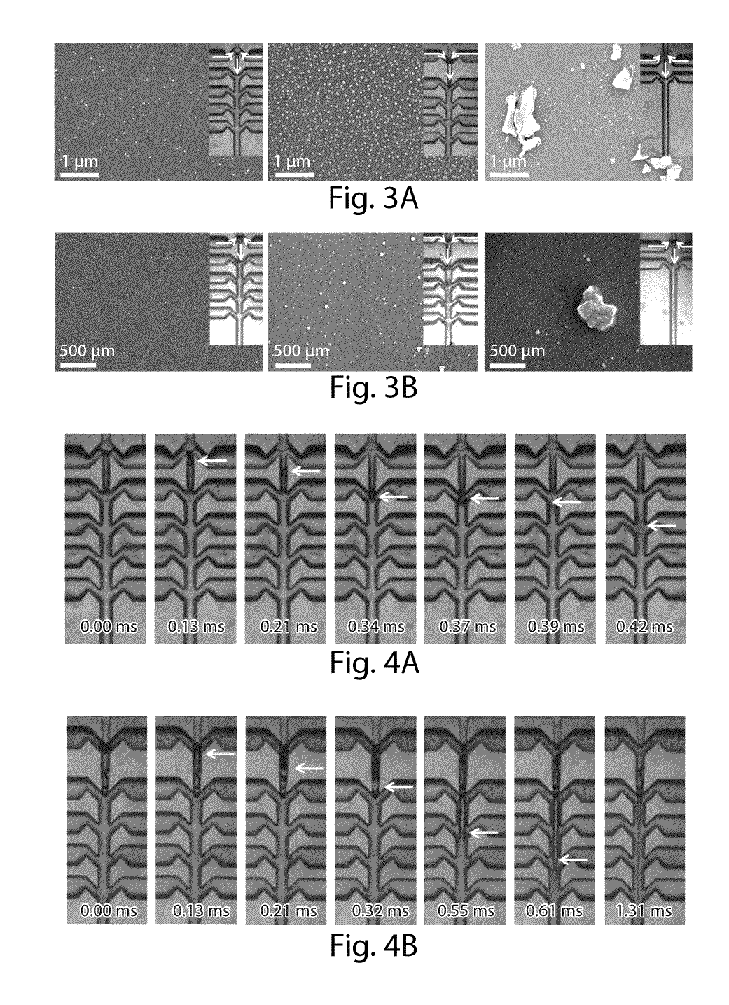

It was found that the number of air inlets in the evaporation unit and the geometry of the nebulization unit impacted the size of the spray dried nanoparticles in this particular configuration. The size of the CaCO₃ and fenofibrate nanoparticles decreased with increasing numbers of air inlets. Furthermore, nebulators containing only one air inlet in the evaporation unit produced a combination of micrometer-sized aggregates and nm sized particles. In contrast, the vast majority of particles produced with nebulators with four air inlet in the evaporation unit had diameters below 30 nm, as can be seen on scanning electron microscopy (SEM) images (FIG. 3).

The flow direction of the air in the air inlet of the nebulization unit, relative to the liquid flow direction, may also influence the size of spray dried nanoparticles. The nebulators where the flow direction of the air in the air inlet of the nebulization unit and the liquid were the same, herewith called the co-flow geometry, were compared with devices where the flow directions of air in the air inlet of the nebulization unit was opposed to the direction of the liquid flow, called the flow-focusing geometry. Spray dried CaCO₃ and fenofibrate nanoparticles produced in nebulators with flow-focusing nebulization units were found to be smaller than particles produced in nebulators with a co-flow nebulization unit (FIG. 3).

In particular, FIG. 3 shows scanning electron micrographs of spray dried nanoparticles. FIG. 3A shows CaCO₃ and FIG. 3B shows fenofibrate nanoparticles spray dried using microfluidic nebulators with different device designs as shown in the respective insets. As shown in each of FIGS. 3A and 3B, the microfluidic nebulators contained a flow-focusing nebulization unit and four air inlets in the evaporation unit (left panel), a co-flow nebulization unit and four air inlets in the evaporation unit (middle panel), or a flow-focusing nebulization unit and one air inlet in the evaporation unit (right panel). The white arrows in the insets in each panel indicate the flow direction of the air in the nebulization unit.

### Example 3

The size of spray-dried CaCO₃ nanoparticles was found to correlate with the ease to operate the microfluidic nebulator in the dripping regime in this particular example. Nebulators with one air inlet in the evaporation unit could only be operated in the jetting regime. Furthermore, no stable dripping regime could be reached for nebulators with a co-flow nebulization geometry, regardless of the number of air inlets in the evaporation unit. In contrast, nebulators with a flow-focusing geometry could be operated in the dripping regime if the evaporation unit contained at least 2 air inlets (FIG. 4).

It is believed that good correlation of the spray dried nanoparticle size and the ability to operate the nebulator in the dripping regime was due to the fact that the acceleration of the liquid phase in the evaporation unit was considerably higher for droplets than for jets (FIG. 4). The strong acceleration of droplets in the evaporation unit broke them up into small secondary droplets that had a higher surface-to-volume ratio, compared to the liquid jet or primary droplets formed in the nebulization unit. Higher surface-to-volume ratios lead to higher evaporation rates of the liquid; this may reduce the time nanoparticles can grow, and may lead to smaller nanoparticles. Thus, in certain embodiments, droplets may be formed inside the microfluidic nebulator.

FIG. 3 shows time lapse images of the drop formation in the microfluidic nebulator, including optical microscopy images of the microfluidic nebulator that had a) a flow-focusing unit and b) a co-flow drop generation unit. The applied pressure was 2.8 bar and the water flow rate was 1 ml/h. The time between the onset of the drop formation and the time the image is taken is denoted on the images. The white arrows indicate the droplets. The scale bar corresponds to 200 micrometers.

In microfluidics, droplets can be formed either in the jetting regime, typically through Rayleigh-Plateau instabilities, or in the dripping regime, where the drop formation is caused by an absolute instability. Instability of the liquid occurs at stagnation points where the velocity times the dynamic viscosity of the continuous phase is substantially equal to the velocity times the dynamic viscosity of the dispersed phases; this would allow operation of the device in the dripping regime.

In this example, the liquid velocity in the nebulization unit was on the order of 0.1 m/s. Operation of the nebulator in the dripping regime required the air velocity to be about 2 m/s. The air velocity was directly related to the pressure gradient. To determine the air velocity in the different sections of the nebulator, the pressure profile was determined in the nebulator by measuring the pressure dependent expansion of the PDMS-based channel sections. The calculated air velocity was compared to the velocities of the droplets in the different channel sections that were measured based movies taken with a high speed camera connected to an optical microscope.

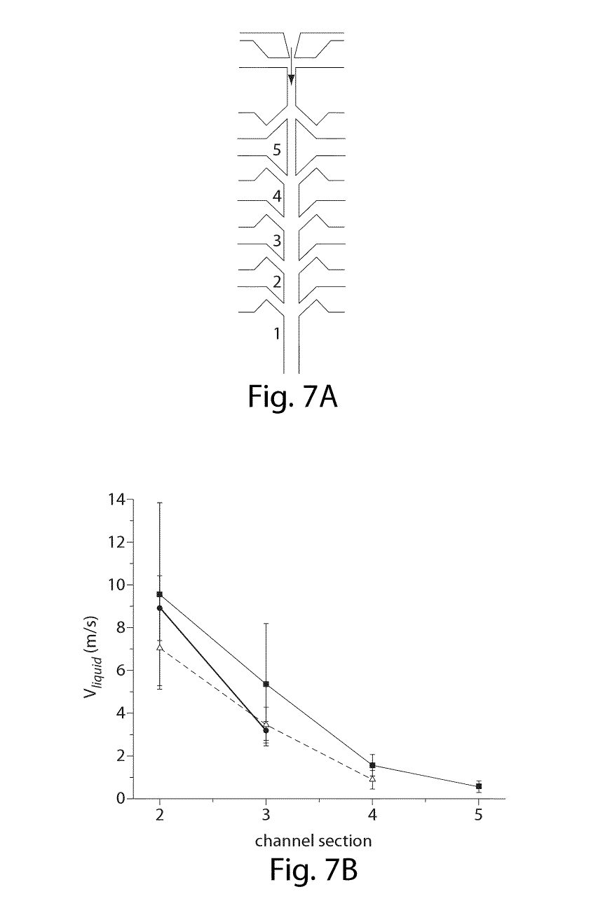

It was found that the pressure drop between two adjacent air inlets sequentially decreased; it was largest between air inlet number 1 and the device outlet, and the smallest in the nebulization unit (FIG. 7). This is in agreement with the increasing acceleration of liquid droplets with decreasing channel section number (Table 1). Furthermore, the pressure drop in the respective channel section was independent of the number of air inlets a device had, as indicated by the insensitivity of the drop speed on the number of air inlets of a nebulator (FIG. 7). Thus, the pressure drop in the nebulization unit was found to decrease with increasing number of air inlets in the evaporation unit in this particular system.

FIG. 7 shows the speed of droplets inside the microfluidic nebulator. FIG. 7A shows a schematic of the microfluidic nebulator with the definition of the different channel sections shown. FIG. 7B shows the speed of drops in the different channel sections of the microfluidic nebulator is measured for microfluidic nebulators that have a flow-focusing nebulization unit and an evaporation unit with two (circles), three (triangles) and four (squares) air inlets.

To relate pressure drops to air velocities in the nebulization unit, the speed of the air at the device outlet was determined as a function of the number of air inlets in the evaporation unit (Table 1). The air velocity in the nebulization unit decreased from 28 m/s for nebulators with one air inlet in their evaporation units to 7 m/s for nebulators with four air inlets in their evaporation unit (Table 2).

To further decrease the y-component of the air velocity vector that is directed parallel to the liquid flow in the nebulization unit, the co-flow nebulization unit was exchanged with a flow-focusing nebulization unit. In the flow focusing nebulization unit, the y-component of the velocity vector of the air that is directed parallel to the liquid flow reached the value required to create a stagnation point as the air flow made a 135° turn to enter the main channel. Thus, as is shown in this non-limiting example, nebulators that contain a flow focusing nebulization unit and at least two air inlets in the evaporation unit can therefore be operated in the dripping regime (FIG. 4).

TABLE 1

| channel section | p (bar) | vₐᵢᵣ (m/s) | v_{liquid} (m/s) | vₐᵢᵣ/v_{liquid} |
|---|---|---|---|---|
| 1 | 2.2 | 547 | | |
| 2 | 2.4 | 32 | 9.6 | 3 |
| 3 | 2.7 | 15 | 5.3 | 3 |
| 4 | 2.8 | 8 | 1.6 | 5 |
| 5 | 2.8 | 7 | 0.6 | 12 |

TABLE 2

| number of air inlets | |
|---|---|
| in evaporation unit | vₐᵢᵣ (m/s) |
| 0 | 547 ± 9 |
| 1 | 637 ± 31 |
| 2 | 688 ± 37 |
| 3 | 714 ± 32 |
| 4 | 737 ± 21 |

### Example 4

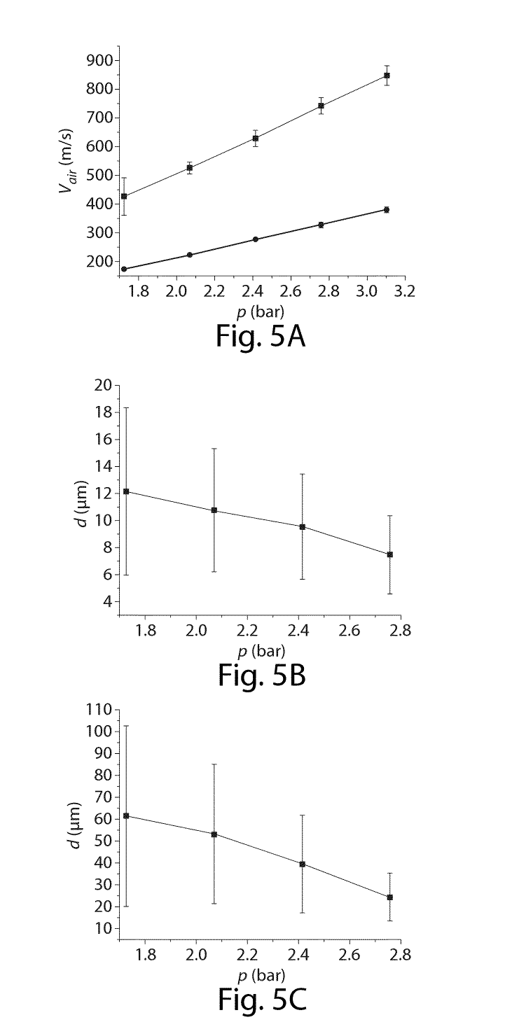

To elaborate on the influence of the applied pressure on the acceleration of the droplets in the evaporation unit, the size of secondary droplets and spray dried nanoparticles, the speed of the air at the device outlet as a function of the applied pressure was studied in this example (FIG. 5A and Table 3). The drop size at the nebulator nozzle was quantified based on movies taken with a high speed camera.

TABLE 3

| p (psi) | p (bar) | vₐᵢᵣ (m/s) | M | pₐᵢᵣ (m³/kg) | δ (μm) |
|---|---|---|---|---|---|
| 25 | 1.7 | 425 ± 65 | 1.3 | 2.0 | 40 |
| 30 | 2.1 | 525 ± 21 | 1.5 | 2.4 | 33 |
| 35 | 2.4 | 628 ± 28 | 1.8 | 2.9 | 28 |
| 40 | 2.8 | 741 ± 27 | 2.2 | 3.3 | 24 |
| 45 | 3.1 | 846 ± 35 | 2.5 | 3.7 | 21 |

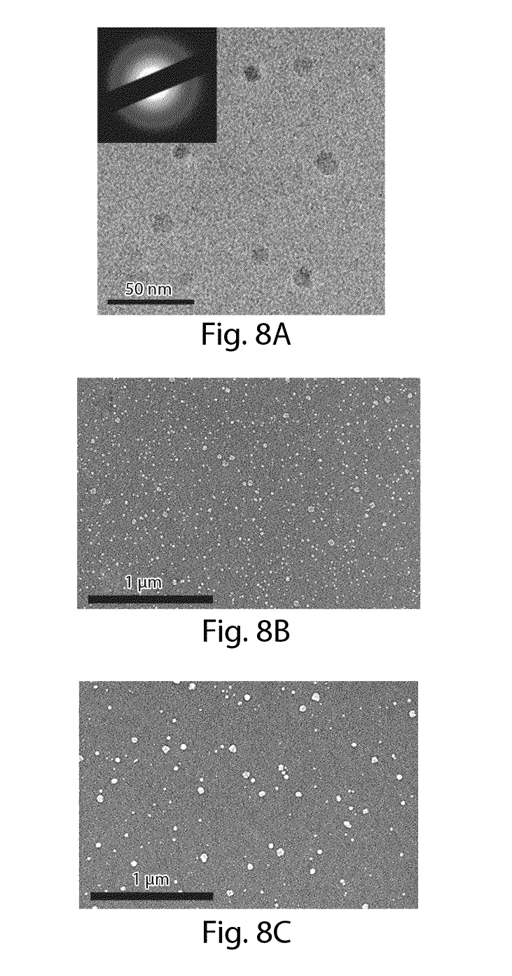

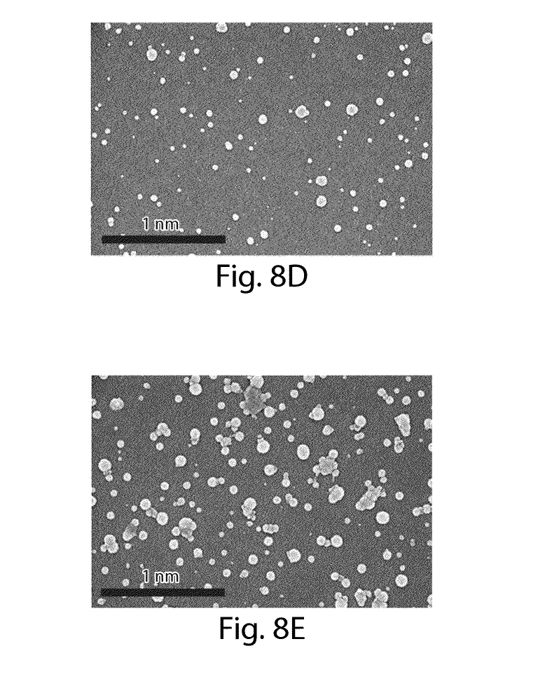

The speed of the air at the device outlet was found to linearly increase with increasing applied pressure (FIG. 5A). Note that the speed of air at the device outlet was supersonic. The increasing air velocity with increasing applied pressure resulted in an increasing acceleration of the droplets in the evaporation unit, leading to a decrease of the size of secondary droplets (FIG. 5B). The increasing surface-to-volume ratio with decreasing drop size directly translated into a decrease of the size of spray dried nanoparticles with increasing applied pressure (FIG. 5C). The decreased particle size with increasing applied pressure was assigned to an increased liquid evaporation rate caused by the higher surface-to-volume ratio of smaller droplets. The increased liquid evaporation rate limited nanoparticle growth time and therefore resulted in smaller spray dried nanoparticles. The CaCO₃ nanoparticles were found to be amorphous as could be seen from the diffraction transmission electron microscopy (TEM) image (FIG. 8).

FIG. 5A shows the air velocity at the nebulator outlet as a function of the pressure applied to the air inlets. The microfluidic nebulator contained a flow-focusing nebulization geometry and an evaporation unit with four air inlets. FIG. 5B shows the diameter of water drops containing CaCO₃ nanoparticles collected on a poly(tetrafluoroethylene) (PTFE) at the device nozzle. FIG. 5C shows the diameter of spray dried CaCO₃ nanoparticles collected 20 cm apart from the microfluidic nebulator outlet on a Si wafer as a function of the pressure applied to the air inlets of the microfluidic nebulator. The microfluidic nebulator contained a flow-focusing nebulization unit and had four air inlets in its evaporation unit. A constant pressure of 2.8 bar was applied to the air inlets and the flow rates of the aqueous CaCl₂ and NaCO₃ solutions were 2×1 ml/h.

FIG. 8 shows TEM (FIG. 8A) and SEM images (FIGS. 8B-8E) of spray dried CaCO₃ nanoparticles. The inset in FIG. 8A shows a TEM diffraction image of CaCO₃ nanoparticles. CaCO₃ nanoparticles were spray dried using a nebulator containing a flow-focusing nebulization unit and an evaporation unit with four air inlets. The flow rates of the aqueous CaCl₂ and CaCO₃ solutions were kept constant at 2×1 ml/h. The pressure at the air inlets was 2.8 bar (FIGS. 8A-8B), 2.4 bar (FIG. 8C), 2.1 bar (FIG. 8D), and 1.7 bar (FIG. 8E). Spray dried nanoparticles were collected 20 cm apart from the microfluidic nebulator outlet.

### Example 5

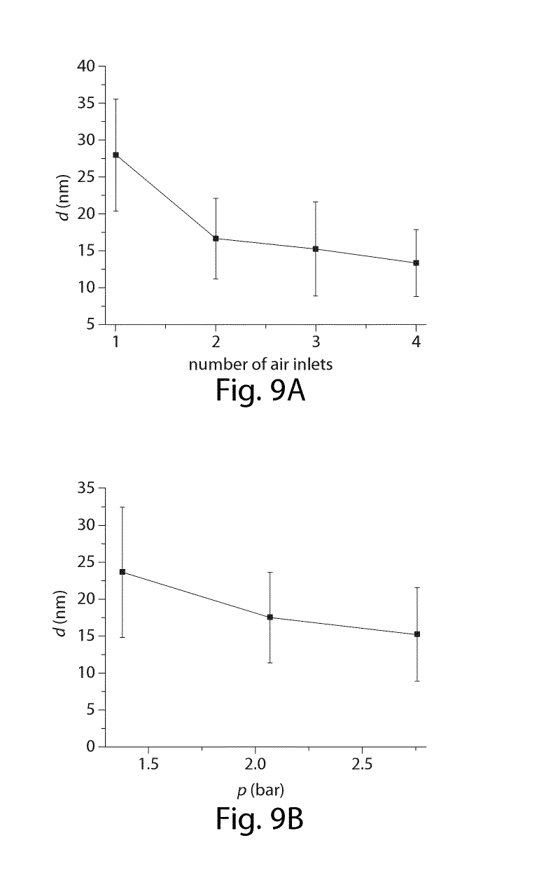

Ethanol effectively wetted PDMS channel walls, preventing drop formation in the nebulization unit in some cases. However, similar to CaCO₃ nanoparticles, the size of spray dried fenofibrate particles decreased with increasing number of air inlets in the evaporation unit and increasing applied pressure (FIG. 9). Furthermore, fenofibrate nanoparticles were smaller if they were spray dried in nebulators that had a flow-focusing unit compared to a co-flow nebulization unit, in analogy to CaCO₃ nanoparticles (FIG. 3). The decrease in fenofibrate nanoparticle size with increasing number of air inlets in the evaporation unit and applied pressure was assigned to the increasing velocities of air at the device outlet. The increased air velocity lead to higher acceleration of the liquid films, more convection and therefore higher solvent evaporation rates.

In FIG. 9, fenofibrate nanoparticles were spray dried with a microfluidic nebulator containing a flow-focusing nebulization unit. FIG. 9A shows the dependence of the fenofibrate nanoparticle size on the number of air inlets the nebulator has in the evaporation unit. The pressure at the air inlets was kept constant at 2.8 bar. FIG. 9B shows that fenofibrate nanoparticles were spray dried using a microfluidic nebulator with four air inlets in the evaporation unit. The fenofibrate nanoparticle size is shown as a function of the pressure applied to the air inlets. Fenofibrate was dissolved in ethanol at 5 mg/ml and the ethanol flow rate during operation of the nebulator was kept constant at 1 ml/h.

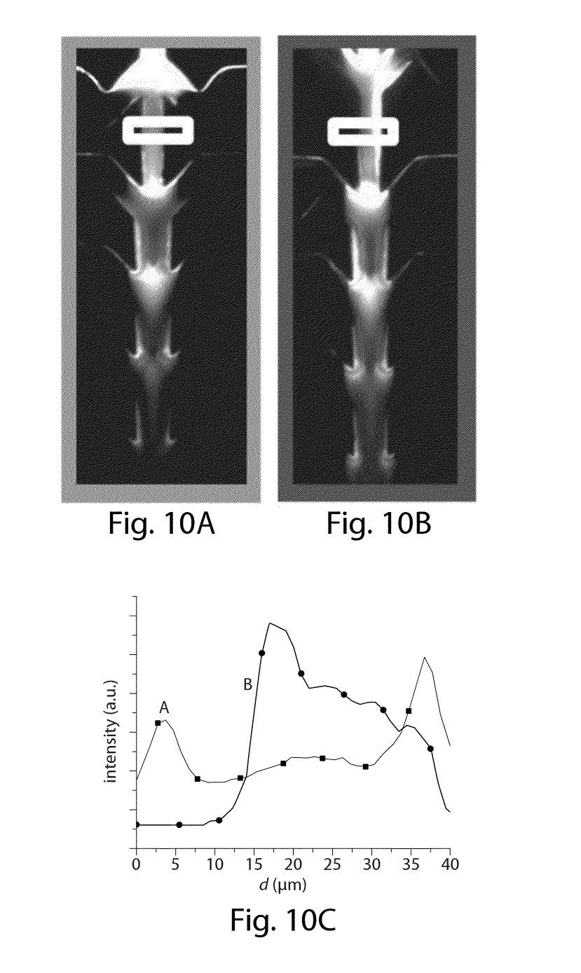

To elucidate possible reasons for the smaller sizes of fenofibrate nanoparticles spray dried with nebulators containing the flow-focusing compared to the co-flow nebulization unit, the flow profile of ethanol was investigated for the two different nebulization units. Ethanol was labeled with fluorescein and fluorescence images recorded during the operation of microfluidic nebulators. The fluorescence intensity profiles measured across the channel in the nebulization unit revealed that ethanol homogeneously wet the channel walls of flow-focusing nebulization units whereas ethanol jets preferentially wet one of the channel walls in co-flow nebulization units (FIG. 10). Thin ethanol films generated in the flow-focusing nebulization unit had a higher surface-to-volume ratio compared to jets produced in the co-flow nebulization unit. This lead to higher ethanol evaporation rates in microfluidic nebulators that had a flow-focusing unit compared to those with a co-flow nebulization unit. The smaller size of fenofibrate nanoparticles spray dried with nebulators containing a flow-focusing unit compared to the co-flow nebulization unit was attributed to the higher ethanol evaporation rates achieved in devices that have a flow-focusing nebulization unit.

Fluorescein labeled ethanol was injected in the microfluidic nebulator at a flow rate of 4 ml/h. FIG. 10 shows fluorescence images of ethanol injected in a microfluidic nebulator with a flow-focusing unit (FIG. 10A) and a co-flow nebulization unit (FIG. 10B) and an evaporation unit with four air inlets. The fluorescent cross section across the nebulization unit shown in FIG. 10C was measured in the area indicated with the square. FIG. 10C shows the fluorescence intensity profile of ethanol across the channel in the nebulization unit is shown for the flow-focusing (squares) and co-flow (circles) nebulization unit, respectively.

### Example 6

The production of sub-30 nm sized nanoparticles in the microfluidic nebulator relied on relatively fast solvent evaporation that may limit the nanoparticle growth time. It therefore is expected to be generally applicable to compounds that can be dissolved in water or volatile solvents.

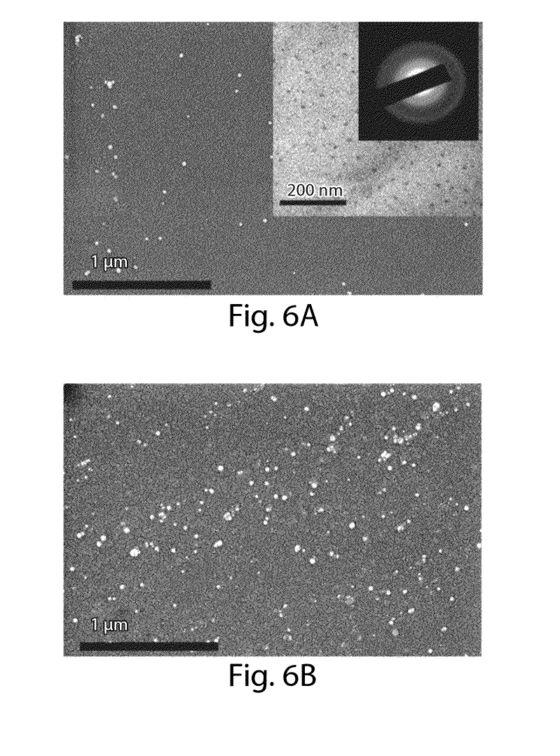

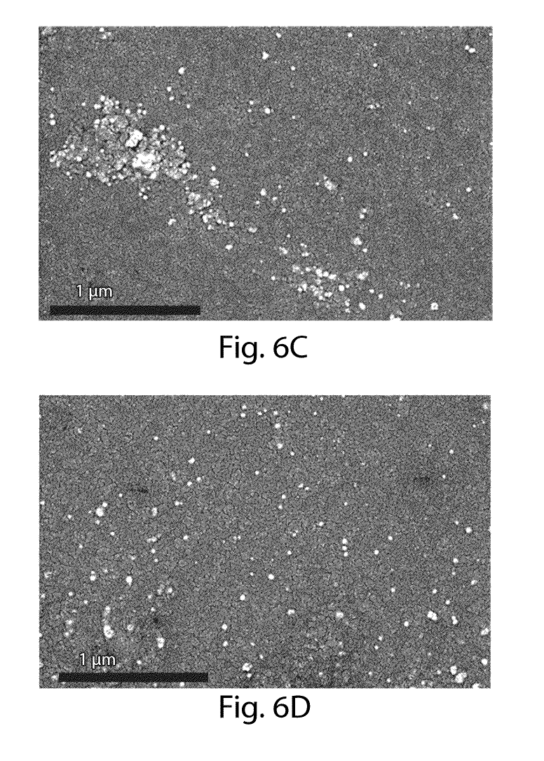

To demonstrate this, three additional hydrophobic drugs, namely clotrimazole, estradiol and danazol were spray dried using the microfluidic nebulator in this example. The average nanoparticle diameters of fenofibrate, clotrimazole, estradiol and danazol were 25+/−5 nm, 24+/−8 nm, 25+/−8 nm and 22+/−7 nm below 30 nm (FIG. 6). The fast solvent evaporation prevented crystallization of these drugs, leading to amorphous nanoparticles as can be seen on the diffraction TEM image in the inset of FIG. 6A. Thus, the microfluidic nebulator appeared to be generally applicable for the formulation of drug nanoparticles and precipitation reactions of inorganic nanoparticles with diameters below 30 nm.

FIG. 6 shows electron microscopy images of spray dried hydrophobic drug nanoparticles. Poorly water soluble drugs, namely fenofibrate (FIG. 6A), clotrimazole (FIG. 6B), danazol (FIG. 6C), and estradiol (FIG. 6D) were dissolved in ethanol and spray dried using a microfluidic nebulator with a flow-focusing nebulization unit and four air inlets in the evaporation unit. A pressure of 2.8 bar is applied to the air inlets and the ethanol solutions are injected at a rate of 1 ml/h. Nanoparticles were collected 10 cm apart from the nebulator outlet. The nanoparticles were imaged with SEM and fenofibrate was additionally analyzed using TEM (inset).

### Example 7

This example discusses materials and methods used in the previous examples.

Materials. Na₂CO₃, trichlorododecylsilane, fluorescein sodium salt and polyethylene glycol mono-acrylate (PEGMA) were obtained from Sigma Aldrich, ethanol from VWR, CaCl₂ from Mallinckrodt Baker, Sylgard PDMS from Dow Corning, and SU2100 from MicroChem Corp. Fenofibrate, clotrimazole, danazol and estradiol were obtained from BASF.

Device fabrication. The microfluidic nebulator with channel heights of 100 micrometers was fabricated using soft lithography. Briefly, masks were designed using AutoCAD and printed with a resolution of 20,000 dpi (dots per inch; 1 inch is 2.54 cm). One side polished Si wafers (University Wafer) were spin coated with SU2100. After the photoresist was pre-baked, the pattern of the mask was projected onto the SU2100 coated Si water through UV illumination (OAI Model 150). UV illumination was followed by post baking and development of the photoresist using PEGMA resulting in masters. Subsequently, PDMS replicas were made from these masters by mixing the base compound and the crosslinker at a weight ratio of 10:1. PDMS replicas were cured at 65° C. for at least 12 h. To avoid shear forces arising due to an uneven deformation of the PDMS and glass, the PDMS devices were bonded to flat PDMS substrates using an oxygen plasma (Gala Instruments). The channel walls were rendered hydrophobic by treating them with tricholorododecylsilane before they were thoroughly rinsed with ethanol and dried with air. The nozzle of the device was formed by slicing the device outlet with a razor blade.

Device operation. Unless stated otherwise, the pressure at the air inlets was set to 2.8 bar (40 psi). The liquid and air phases were injected into the microfluidic device using polyethylene tubings with an inner diameter of 0.33 mm (Scientific Commodities Inc.). The operation of the microfluidic nebulator was monitored using a high-speed camera (Phantom V7.3) operated at a rate of 38,000 fps.

The CaCO₃ nanoparticles were synthesized from aqueous solutions containing 5 mM Na₂CO₃ and CaCl₂ respectively. The solutions were injected in the nebulator at a flow rate of 2×1 ml/h using volume controlled peristaltic pumps (Harvard Apparatus PHD2000 Infusion Syringe Pumps). Unless stated otherwise, fenofibrate, clotrimazole, danazol and estradiol were dissolved in ethanol at 45 mg/ml, 80 mg/ml, 25 mg/ml and 20 mg/ml, corresponding to approximately 90% of their saturation concentrations. They were injected into the nebulator at a rate of 1 ml/h. The hydrophobic drugs were collected 10 cm apart from the nebulator outlet while CaCO₃ nanoparticles were collected 20 cm apart from the device outlet. To visualize the liquid flow profile of ethanol, ethanol was stained with 1 mg/ml fluorescein sodium salt.

Sample characterization. To visualize the dried nanoparticles with scanning electron microscopy (SEM), the samples were collected on one side of a polished Si water. The samples were subsequently coated with Pt/Pd and visualized with an Ultra55 Field Emission SEM (Zeiss) operated at an extraction voltage of 5 kV using an in-lens detector. For TEM analysis, samples were collected on a carbon coated 300 mesh Cu-grid (Electron Sciences). They were imaged with a JEOL2100 TEM operated at 80 kV.

### Example 8

To relate the performance of the microfluidic nebulator to the commercially available counterparts, this example compares the nebulator with the commercially available Nano Buchi spray drier. The Nano Buchi spray drier is designed to produce sub-micrometer sized spray dried nanoparticles. The nanoparticles formulated using the microfluidic nebulator were 10-100 times smaller compared to particles spray dried with the Nano Buchi spray drier. The air flow rate in the microfluidic nebulator was 20 l/h, which was 300-500 times lower than the air flow in the Nano Buchi spray drier. The capacity of the microfluidic nebulator to dry water of approximately 2 ml/h is 100 times below that of the Nano Buchi spray drier. Thus, to reach throughput that is comparable to the commercially-available Nano Buchi spray drier, about 100 microfluidic nebulators would have to be run in parallel. This can be easily achieved if microfluidic nebulators are parallelized.

To show the feasibility of parallelizing microfluidic nebulators, three adjacent nebulators with 450 micrometers tall and 1.5 mm wide distribution channels were connected in this example; this allowed simultaneous operation of three microfluidic nebulators. However, the parallelization strategy employed here was not limited to parallelizing three microfluidic nebulators but could also be extended to parallelize many nebulators. Because of the ability to operate microfluidic nebulators in the dripping regime if water-based solutions are spray dried, the ability to formulate actives dissolved in organic solutions as nanoparticles in microfluidic nebulators and the possibility to up-scale the production of nanoparticles by parallelizing nebulators, the microfluidic nebulator discussed in this example is useful for the production for non-agglomerated nanoparticles.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A spray dryer for use in drying liquids, comprising:
an article comprising:
a first microfluidic channel;
second and third microfluidic channels each intersecting the first microfluidic channel at substantially non-right angles at a first intersection; and
fourth and fifth microfluidic channels each intersecting the first microfluidic channel at substantially non-right angles at a second intersection; and
a collection region that receives output from the first microfluidic channel.

2. The spray dryer of claim 1, wherein the second intersection is downstream of the first intersection.

3. The spray dryer of any one of claim 1 or 2, wherein the substantially non-right angles at the first intersection are each obtuse angles.

4. The spray dryer of any one of claims 1-3, wherein the substantially non-right angles at the first intersection are each about 135°.

5. The spray dryer of any one of claims 1-4, wherein the substantially non-right angles at the second intersection are each acute angles.

6. The spray dryer of any one of claims 1-5, wherein the substantially non-right angles at the second intersection are each about 45°.

7. The spray dryer of any one of claims 1-6, further comprising sixth and seventh microfluidic channels each intersecting the first microfluidic channel at substantially non-right angles at a third intersection.

8. The spray dyer of claim 7, wherein the substantially non-right angles at the third intersection are each acute angles.

9. The spray dryer of any one of claim 7 or 8, wherein the substantially non-right angles at the third intersection are each about 45°.

10. The spray dryer of any one of claims 7-9, further comprising eighth and ninth microfluidic channels each intersecting the first microfluidic channel at substantially non-right angles at a fourth intersection.

11. The spray dryer of claim 10, further comprising tenth and eleventh microfluidic channels each intersecting the first microfluidic channel at substantially non-right angles at a fourth intersection.

12. The spray dryer of any one of claims 1-11, wherein the first microfluidic channel is in fluid communication with a first source of liquid, and the second microfluidic channel is in fluid communication with a second source of liquid.

13. The spray dryer of claim 12, wherein the liquid of the first source of liquid and the liquid of the second source of liquid are substantially immiscible.

14. The spray dryer of any one of claims 1-13, wherein the third microfluidic channel is in fluidic communication with a source of fluid.

15. The spray dryer of claim 14, wherein the source of fluid is a source of liquid.

16. The spray dryer of claim 14, wherein the source of fluid is a source of gas.

17. The spray dryer of claim 16, wherein the source of gas is a source of air.

18. The spray dryer of any one of claims 1-17, wherein the first microfluidic channel comprises an opening directed at the collection region.

19. The spray dryer of claim 18, wherein the opening has a cross-sectional aspect ratio of about 1:1.

20. The spray dryer of claim 18, wherein the opening has a cross-sectional aspect ratio of at least about 3:1.

21. The spray dryer of any one of claims 1-20, wherein the collection region is a drying region.

22. The spray dryer of any one of claims 1-21, further comprising a heater for heating the collection region.

23. The spray dryer of claim 22, wherein the heater is able to heat the collection region to a temperature of at least about 40° C.

24. The spray dryer of any one of claim 22 or 23, wherein the heater is able to heat the collection region to a temperature of at least about 60° C.

25. The spray dryer of any one of claims 1-24, wherein the collection region is at least partially enclosed.

26. The spray dryer of any one of claims 1-25, wherein the collection region is contained in a chamber.

27. The spray dryer of any one of claims 1-26, wherein the first microfluidic channel has an average cross-sectional dimension of less than about 1 mm.

28. The spray dryer of any one of claims 1-27, wherein the first microfluidic channel has a cross-sectional aspect ratio of about 1:1.

29. The spray dryer of any one of claims 1-27, wherein the first microfluidic channel has a cross-sectional aspect ratio of at least about 5:1.

30. The spray dryer of any one of claims 1-29, wherein the article comprises an elastomeric polymer.

31. The spray dryer of any one of claims 1-30, wherein the article consists essentially of an elastomeric polymer.

32. The spray dryer of any one of claims 1-31, wherein the article comprises polydimethylsiloxane.

33. The spray dryer of any one of claims 1-32, wherein the article is substantially planar.

34. The spray dryer of any one of claims 1-33, wherein the article is mechanically deformable.

35. The spray dryer of any one of claims 1-34, wherein channels within the article are arranged to be quasi-2-dimensional.

36. The spray dryer of any one of claims 1-35, wherein at least a portion of the first microfluidic channel is coated with a hydrophobic coating.

37. The spray dryer of any one of claims 1-36, wherein at least a portion of the first microfluidic channel is hydrophobic.

38. The spray dryer of any one of claims 1-37, wherein substantially all of the first microfluidic channel is hydrophobic.

39. The spray dryer of any one of claims 1-38, wherein substantially each of the microfluidic channels is hydrophobic.

40. An apparatus, comprising at least 10 spray dryers as recited in any one of claims 1-39.

41. A method of evaporating a liquid, comprising:
passing a liquid through a microfluidic channel such that at least about 20 vol % of the liquid evaporates while the liquid is contained within the microfluidic channel.

42. The method of claim 41, wherein the liquid is present as droplets.

43. The method of claim 41, wherein the liquid is present as a liquid film.

44. The method of claim 41, wherein the liquid is present as a jet.

45. The method of any one of claims 41-44, wherein at least about 75 vol % of the liquid evaporates while the liquid is contained within the microfluidic channel.

46. The method of any one of claims 41-45, wherein the liquid comprises water.

47. The method of any one of claims 41-46, wherein the liquid comprises ethanol.

48. The method of any one of claims 41-47, wherein the liquid is miscible in water.

49. The method of any one of claims 41-47, wherein the liquid is immiscible in water.

50. The method of any one of claims 41-49, wherein the fluidic droplets have an overall average cross-sectional dimension of less than about 1 mm.

51. The method of any one of claims 41-50, wherein the liquid flows through the microfluidic channel without contacting a wall of the microfluidic channel.

52. The method of any one of claims 41-51, wherein the liquid within the microfluidic channel is surrounded by a gas.

53. The method of claim 52, wherein the gas is air.

54. The method of any one of claim 52 or 53, wherein the gas, upon initial contact with the liquid, is at a temperature of at least about 40° C.

55. The method of any one of claims 41-54, wherein the liquid solidifies into particles as the liquid solvent evaporates therefrom.

56. The method of claim 55, wherein the liquid solidifies into particles prior to exiting the microfluidic channel.

57. The method of claim 55, wherein the liquid solidifies into particles after exiting the microfluidic channel.

58. The method of any one of claim 55-57, wherein the particles have an average cross-sectional dimension of less than about 1 mm.

59. The method of any one of claims 41-58, wherein the microfluidic channel has an average cross-sectional dimension of less than about 1 mm.

60. A method of spray drying a liquid, comprising:
passing a liquid through a microfluidic channel such that at least about 25 vol % of the liquid evaporates within the microfluidic channel; and
spraying the unevaporated liquid into a collection region external of the microfluidic channel.

61. A method of dispersing a fluidic droplet, comprising:
dispersing a fluidic droplet contained within a microfluidic channel into smaller fluidic droplets by accelerating the fluidic droplet within the microfluidic channel.

62. The method of claim 61, comprising accelerating the fluidic droplet by introducing fluid into the microfluidic channel.

63. The method of claim 62, comprising accelerating the fluidic droplet at a plurality of locations within the channel by introducing fluid into the microfluidic channel at at least some of the locations.

64. The method of any one of claim 62 or 63, wherein the average velocity of the fluidic droplet within the microfluidic channel increase by at least about 20% after introducing the fluidic droplet into the microfluidic channel.

65. The method of any one of claims 62-64, wherein the average velocity of the fluidic droplet within the microfluidic channel increase by at least about 50% after introducing the fluid into the microfluidic channel.

66. The method of any one of claims 61-65, wherein the fluidic droplet elongates and disrupted into smaller fluidic droplets by accelerating the fluidic droplet within the microfluidic channel.

67. The method of any one of claims 61-66, comprising accelerating the fluidic droplet electrically.

68. The method of any one of claims 61-67, comprising accelerating the fluidic droplet magnetically.

69. The method of any one of claim 61-68, wherein the fluidic droplet comprises a liquid.

70. The method of claim 69, wherein, during acceleration of the fluidic droplets, at least some of the liquid evaporates.

71. A method, comprising:
providing a supersaturated fluidic droplet contained within a microfluidic channel; and
directing the supersaturated fluidic droplet out of the microfluidic channel at a surface.

72. The method of claim 71, wherein providing a supersaturated fluidic droplet comprises:
providing a fluidic droplet; and
causing the liquid to evaporate such that the fluidic droplet becomes supersaturated.

73. The method of claim 72, comprising exposing the fluidic droplet to a gas that the liquid is able to evaporate into.

74. The method of any one of claims 71-73, wherein the surface is the surface of a collection chamber.

75. The method of any one of claims 71-74, wherein the liquid comprises water.

76. The method of any one of claims 71-75, wherein the fluidic droplet further comprises a pharmaceutical agent.
